(19) United States
(12) Patent Application Publication
(10) Pub. No.: US 2025/0234270 A1
(43) Pub. Date: Jul. 17, 2025

(54) PROSE MULTI-HOP U2N RELAY SECURITY

(71) Applicant: QUALCOMM Incorporated, San Diego, CA (US)

(72) Inventors: Soo Bum LEE, San Diego, CA (US); Hongil KIM, San Diego, CA (US)

(21) Appl. No.: 18/410,978

(22) Filed: Jan. 11, 2024

(51) Int. Cl. H04W 40/24; H04W 12/106; H04W 40/22; H04W 88/04

(52) U.S. Cl. CPC H04W 40/246; H04W 12/106; H04W 40/22; H04W 88/04

(57) ABSTRACT

A user equipment (UE) is configured to receive a discovery message associated with UE-to-network relayed communication, determine a multiple hop discovery based at least on the discovery message; and verify the discovery message, wherein the discovery message is at least integrity protected. A UE is configured to determine a multiple hop path for UE-to-network relayed communication; and perform a security procedure for the UE-to-network relayed communication via the multiple hop path including a donor relay UE and at least one intermediate relay UE between the UE and a wireless network.

### TECHNICAL FIELD

The present disclosure relates generally to communication systems, and more particularly, to a user equipment (UE) to network (U2N) relay for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to receive a discovery message associated with UE-to-network relayed communication; determine a multiple hop discovery based at least on the discovery message; and verify the discovery message, wherein the discovery message is at least integrity protected.

In an aspect of the disclosure, a method, a computer-readable medium, and an apparatus are provided for wireless communication at a relay UE. The apparatus is configured to receive a discovery message associated with UE-to-network relayed communication; determine a multiple hop relaying of the discovery message; increment a hop count for the discovery message; protect integrity of the discovery message; and forward the discovery message having an incremented hop count.

In an aspect of the disclosure, a method, a computer-readable medium, and an apparatus are provided for wireless communication at a UE. The apparatus is configured to determine a multiple hop path for UE-to-network relayed communication with a wireless network, the multiple hop path including multiple relay UEs between the UE and the wireless network; perform a security procedure for the UE-to-network relayed communication via the multiple hop path to the wireless network; and exchange communication with the wireless network via the multiple hop path based on the security procedure.

In an aspect of the disclosure, a method, a computer-readable medium, and an apparatus are provided for wireless communication at a donor relay UE. The apparatus is configured to determine a multiple hop path for UE-to-network relayed communication; and perform a security procedure for the UE-to-network relayed communication via the multiple hop path including the donor relay UE and at least one intermediate relay UE between the UE and a wireless network.

In an aspect of the disclosure, a method, a computer-readable medium, and an apparatus are provided for wireless communication at an intermediate relay UE. The apparatus is configured to perform, at the intermediate relay UE, a security procedure for UE-to-network relayed communication via a multiple hop path between the UE and a wireless network; and forward communication between the wireless network and the UE via a donor relay UE based on the security procedure.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating aspects of a ProSe system architecture associated with the use of a UE-to-network (U2N) relay in accordance with some aspects of the disclosure.

FIG. 5A and FIG. 5B are call flow diagrams illustrating a set of discovery messages associated with a method of relay UE discovery in accordance with some aspects of the disclosure.

FIG. 6 is a call flow diagram illustrating a method associated with a user plane-based security procedure for a single hop U2N relay in accordance with some aspects of the disclosure.

FIG. 7 is a call flow diagram illustrating a method associated with a control plane-based security procedure for a single hop U2N relay in accordance with some aspects of the disclosure.

FIG. 8 is a call flow diagram illustrating a method associated with a user plane-based security procedure for a multiple hop U2N relay in accordance with some aspects of the disclosure.

FIG. 9 is a call flow diagram illustrating a method associated with a user plane-based security procedure for a multiple-hop U2N relay in accordance with some aspects of the disclosure.

FIG. 10 is a call flow diagram illustrating a method associated with a control plane-based security procedure for a multiple-hop U2N relay in accordance with some aspects of the disclosure.

FIG. 11 is a flowchart of a method of wireless communication in accordance with some aspects of the disclosure.

FIG. 12 is a flowchart of a method of wireless communication in accordance with some aspects of the disclosure.

FIG. 13 is a flowchart of a method of wireless communication in accordance with some aspects of the disclosure.

FIG. 14 is a flowchart 1 of a method of wireless communication in accordance with some aspects of the disclosure.

FIG. 15 is a flowchart of a method of wireless communication in accordance with some aspects of the disclosure.

FIG. 16 is a flowchart of a method of wireless communication in accordance with some aspects of the disclosure.

FIG. 17 is a flowchart of a method of wireless communication in accordance with some aspects of the disclosure.

FIG. 18 is a diagram illustrating an example of a hardware implementation for an example apparatus and/or UE.

FIG. 19 is a diagram illustrating an example of a hardware implementation for an example apparatus and/or relay UE.

### DETAILED DESCRIPTION

In some aspects of wireless communication, a wireless device (or UE) may use a relay UE, or be available for use as a relay UE, for communication with a network (e.g., associated with a U2N relay). The use of a relay may be supported for a single relay UE providing connectivity (e.g., via a sidelink (SL) connection) between a remote UE and a network (e.g., a base station). Security procedures for a U2N relay may be associated with (restricted) relay discovery for an SL (e.g., PC5) connection, PC5 (e.g., sidelink) link establishment, and privacy procedures (e.g., a link identifier update procedure). In some aspects, SL link establishment may be associated with a layer-3 (L3) user-plane security procedure, a L3 control-plane security procedure, or a layer-2 (L2) procedure.

Various aspects relate generally to allowing and/or enabling multi-hop U2N relay for extended coverage. Some aspects more specifically relate to additional security features to support multi-hop U2N relays. In some examples, a remote UE is configured to receive a discovery message associated with UE-to-network relayed communication; determine a multiple hop discovery based at least on the discovery message; and verify the discovery message, wherein the discovery message is at least integrity protected. In some aspects, a relay UE is configured to receive a discovery message associated with UE-to-network relayed communication; determine a multiple hop relaying of the discovery message; increment a hop count for the discovery message; protect integrity of the discovery message; and forward the discovery message having an incremented hop count.

Aspects may include a remote UE, relay UE, or donor UE determining a multiple hop path for UE-to-network relayed communication; and performing a security procedure for the UE-to-network relayed communication via the multiple hop path including the donor relay UE and at least one intermediate relay UE between the UE and a wireless network.

For multi-hop U2N relay, the present disclosure provides enhancement to security for U2N relay discovery, where a discovery message is integrity protected. Aspects provide improved security for a hop-by-hop PC5 link establishment (e.g., from a donor relay UE to a remote UE), e.g., where a remote UE performs an indirect U2N relay security establishment procedure with a donor relay UE multi-hop.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

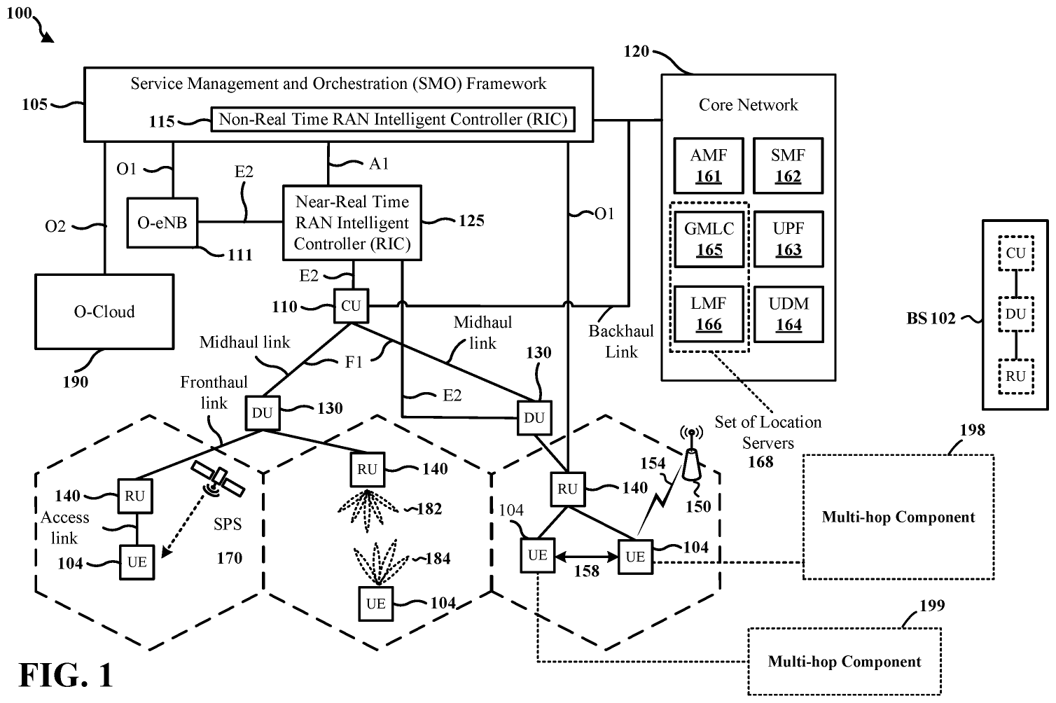

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU), etc. Sidelink communication may be exchanged using a PC5 interface, in some aspects. D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a multi-hop component 198 that may be configured to receive a discovery message associated with UE-to-network relayed communication; determine a multiple hop discovery based at least on the discovery message; and verify the discovery message, wherein the discovery message is at least integrity protected. In some aspects, the multi-hop component may be configured to determine a multiple hop path for UE-to-network relayed communication; perform a security procedure for the UE-to-network relayed communication via the multiple hop path to a wireless network; and exchange communication with the wireless network via the multiple hop path based on the security procedure.

In some aspects a UE, e.g., as a relay UE, such as a donor UE or an intermediate relay UE, may include a multi-hop component 199 configured to receive a discovery message associated with UE-to-network relayed communication; determine a multiple hop relaying of the discovery message; increment a hop count for the discovery message; protect integrity of the discovery message; and forward the discovery message having an incremented hop count. The multi-hop component 199 may be configured to determine a multiple hop path for UE-to-network relayed communication; and perform a security procedure for the UE-to-network relayed communication via the multiple hop path including the donor relay UE and at least one intermediate relay UE between the UE and a wireless network. The multi-hop component 199 may be configured to perform, at the intermediate relay UE, a security procedure for UE-to-network relayed communication via a multiple hop path between the UE and a wireless network; and forward communication between the wireless network and the UE via a donor relay UE based on the security procedure. As described herein, in some aspects, a UE may function as a remote UE at a first time, and at another time may function as a relay UE (e.g., a donor UE or an intermediate relay UE). Thus, a single UE may include the multi-hop component 198 and the multi-hop component 199, in some aspects.

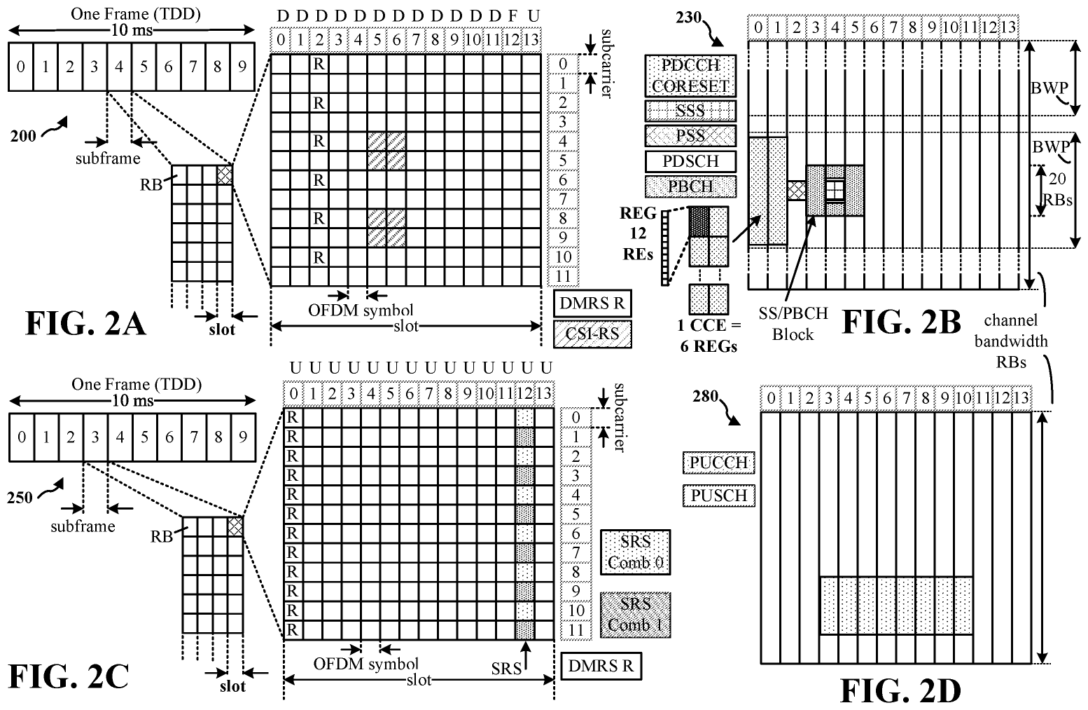

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix is normal or extended. For normal cyclic prefix, each slot may include 14 symbols, and for extended cyclic prefix, each slot may include 12 symbols. The symbols on DL may be cyclic prefix orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the cyclic prefix and the numerology. The numerology defines the subcarrier spacing (SCS) (see Table 1). The symbol length/duration may scale with 1/SCS.

TABLE 1
Numerology, SCS, and Cyclic Prefix

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal cyclic prefix (14 symbols/slot), different numerologies μ 0 to 4 allow for 1, 2, 4, 8, and 16 slots, respectively, per subframe. For extended cyclic prefix, the numerology 2 allows for 4 slots per subframe. Accordingly, for normal cyclic prefix and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal cyclic prefix with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and cyclic prefix (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

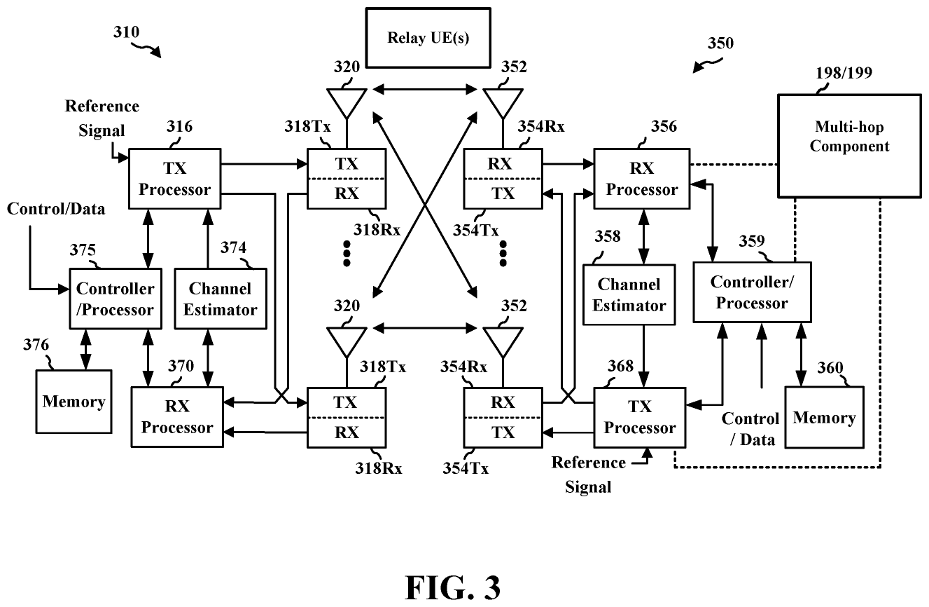

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the multi-hop component 198 and/or the multi-hop component 199 of FIG. 1.

In some aspects of wireless communication, a wireless device (or UE) may use a relay UE for communication with a network (e.g., associated with a U2N relay). The communication may be referred to as U2N communication, in some aspects. The relay may be referred to as a U2N relay, a relay UE, a U2N relay UE, or by other names. The UE that communicates with the network via the relay may be referred to as a remote UE, in some aspects. The relay UE may provide connectivity (e.g., via a SL connection) between a remote UE and a wireless network (e.g., a base station of the wireless network). The communication between the remote UE and the relay UE may be sidelink communication, and the communication between the relay UE and the network may be Uu communication, for example. Security procedures for a U2N relay may be associated with (restricted) relay discovery for an SL (e.g., PC5) connection, PC5 (e.g., sidelink) link establishment, and privacy procedures (e.g., a link identifier update procedure). In some aspects, SL link establishment may be associated with a L3 user-plane security procedure, a L3 control-plane security procedure, or a L2 procedure. Security mechanisms may be based on U2N relay with a single hop or single relay. Aspects presented herein enable security for multi-hop U2N relay in which a path between the remote UE and the network includes multiple relay UEs.

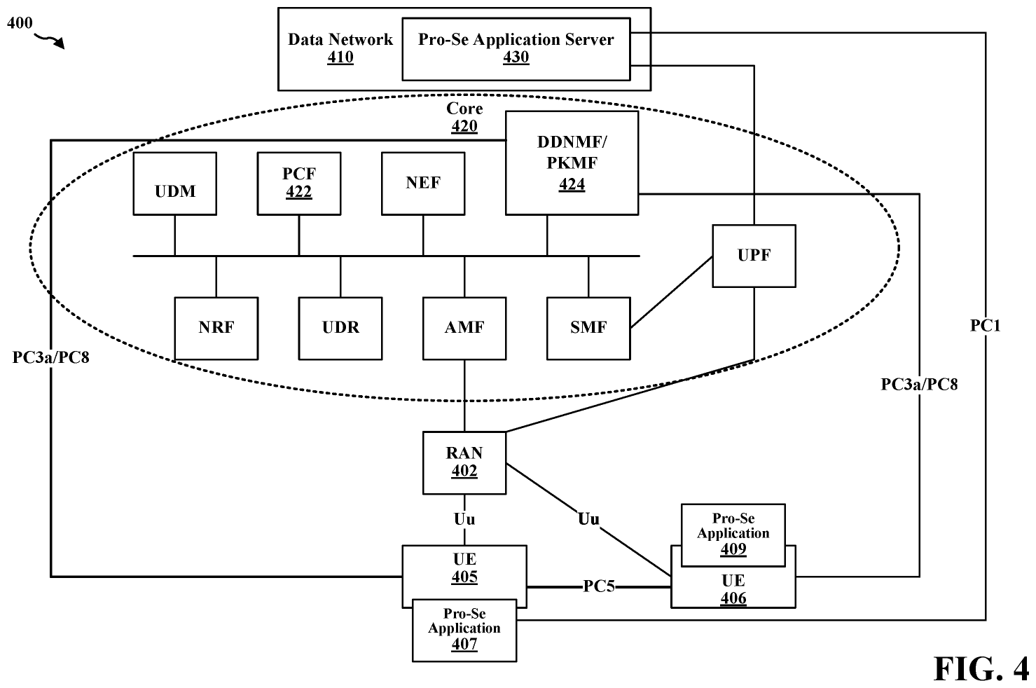

FIG. 4 is a diagram 400 illustrating aspects of a ProSe system architecture that supports a U2N relay in accordance with some aspects of the disclosure. Diagram 400 illustrates a UE 405 and a UE 406 both having (or supporting) a connection to the RAN 402 (e.g., a base station associated with the RAN 402 such as an NG-RAN) via a UE-UTRAN (Uu) link. In some aspects, one of the UEs may be out of coverage of the RAN 402 and may establish a connection to the RAN via the other UE. The UE 405 and the UE 406 may further be connected to each other via a PC5 link (e.g., a SL for direct communication). The UEs 405 and 406 may be connected to aspects of a core network 420 (e.g., Direct Discovery Name Management Function (DDNMF)/ProSe Key Management Function (PKMF) 424) via a PC3a or PC8 link. The UEs 405 and 406 may further be associated with a ProSe application 407 or a ProSe application 409, respectively, that may be connected to a ProSe application server 430 via a PC1 link.

In some aspects, the core network 420 may include a Policy Control Function (PCF) 422 that may provision the UE 405 and/or the UE 406 with a ProSe policy and may provide security materials and PC5 security policies. The DDNMF/PKMF 424, in some aspects, may provide (e.g., via the DDNMF) ProSe code and corresponding discovery security materials. In some aspects, the ProSe application server 430 may perform a service authorization of ProSe UEs (e.g., 405 and 406). In the discussion below the elements and functions of the core network 420 and the data network 410 (and specifically the ProSe application server 430) may be referred to simply as a core or core network and functions performed by the core and/or core network may include communication between elements of the core network used to perform the functions.

Security may include relay discovery security, such as scrambling, message specific confidentiality, and/or integrity protection. Security materials may be provisioned by a PKMF and may be associated with a relay service code (RSC). Relay discovery security may support different modes of discovery, e.g., model A and model B discovery. Security aspects may include unicast PC5 link security, e.g., including the authorization of a remote UE and unicast PC5 link security key material provisioning by a PKMF. Such PC5 link security may support for user plane (UP) and control plane (CP) approaches. Aspects may be applied for L3 and/or L2 U2N relays.

In some aspects, a U2N relay discovery process may be configured to allow authorized UEs to discover other UEs or services. A first model, or mode of operation, of U2N relay discovery (e.g., Model A U2N relay discovery), in some aspects, may include a U2N relay UE announcing its capability to act as a U2N relay device. In some aspects, a second model, or mode of operation, of U2N relay discovery (e.g., Model B U2N relay discovery) may include a U2N relay query and response. The discovery messages, in some aspects, may be integrity protected, scrambled, and/or confidentiality protected as configured and/or determined by a network. In some aspects, scrambling (for confidentiality) may apply to up to 32B of the discovery message (where a discovery message may be as large as 9 kB due to the introduction of application-specific metadata). Confidentiality protection, in some aspects, may apply to at least a part of the discovery message. Verification of the discovery message, in some aspects, may be performed at the UE.

In some aspects of multi-hop U2N relay, the system architecture may include a remote UE with indirect connectivity to a network (e.g., a base station) via two or more U2N relay UEs. The two or more relay UEs may include a donor U2N relay UE (which may be referred to as a donor UE, a donor relay UE, a U2N donor relay UE, a U2N relay UE, or a relay UE) and one or more intermediate U2N relay UEs (which may be referred to as an intermediate UE, an intermediate relay UE, a U2N intermediate relay UE, a U2N relay UE, or a relay UE) as two types of relay UEs. The donor U2N relay UE may be the relay UE that connects to the network (or base station) directly and provides network connectivity to a first intermediate U2N relay UE (directly) and any additional intermediate U2N relay UEs and a remote UE (indirectly). The intermediate U2N relay UEs each connect to the network indirectly and provide network connectivity to at least one additional UE (e.g., an additional intermediate U2N relay UE or a remote UE).

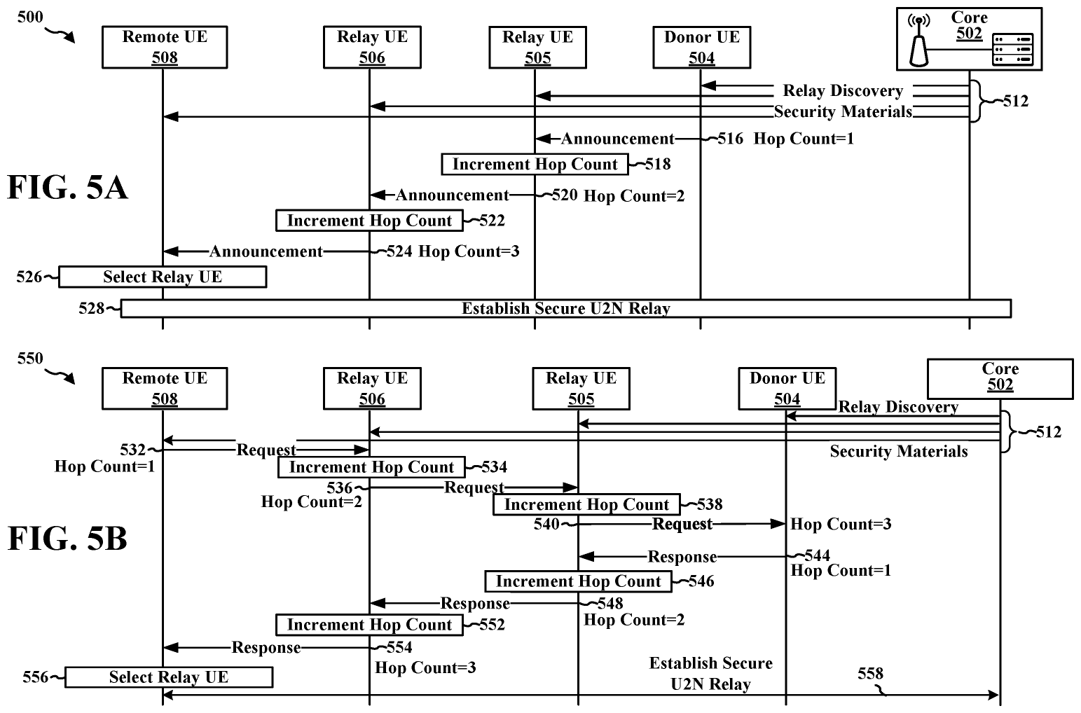

FIG. 5A and FIG. 5B are call flow diagrams, e.g., 500 and 550, illustrating a set of discovery messages associated with a method of relay UE discovery in accordance with some aspects of the disclosure. Call flow diagram 500 illustrates aspects associated with a core network 502, a donor UE 504 (e.g., a first relay UE or donor U2N relay UE), a first intermediate relay UE 505 (e.g., a first intermediate U2N relay UE), a second intermediate relay UE 506 (e.g., a second intermediate U2N relay UE), and a remote UE 508 for a discovery announcement message, e.g., such as in model A discovery. FIG. 5B illustrates example aspects for a discovery solicitation and reply, e.g., such as in model B discovery.

The aspects are illustrated in relation to a core network 502 (e.g., as an example of a network device or network node and associated elements of a core network that may include one or more components of a disaggregated base station) in communication with at least the donor UE 504, the first intermediate relay UE 505, the second intermediate relay UE 506, and the remote UE 508 (e.g., as examples of wireless devices). The functions ascribed to the core network 502, in some aspects, may be performed by one or more components of a core network, a network entity, a network node, or a network device (a single network entity/node/device or a disaggregated network entity/node/device as described above in relation to FIG. 1 or an element of a core network as described above in relation to FIG. 4). Similarly, the functions ascribed to the UEs (e.g., the donor UE 504, the first intermediate relay UE 505, the second intermediate relay UE 506, and the remote UE 508), in some aspects, may be performed by one or more components of a wireless device supporting communication with a network entity/node/device. Accordingly, references to “transmitting” in the description below may be understood to refer to a first component of the core network 502 (or a UE) outputting (or providing) an indication of the content of the transmission to be transmitted by a different component of the core network 502 (or the UE). Similarly, references to “receiving” in the description below may be understood to refer to a first component of the core network 502 (or the UE) receiving a transmitted signal and outputting (or providing) the received signal (or information based on the received signal) to a different component of the core network 502 (or the UE).

Relay discovery materials may be provisioned for each remote UE (e.g., 508) and relay UE (e.g., 504, 505, 506). The core network 502, in some aspects, may provide and the first intermediate relay UE 505, the second intermediate relay UE 506, and the remote UE 508 may receive, relay discovery security materials 512. The relay discovery security materials may indicate one or more parameters associated with integrity protection for discovery-related messages. Based on the relay discovery security materials 512, the remote UE 508 may initiate a U2N discovery solicitation request 532 (e.g., for Model B U2N relay discovery), as shown in FIG. 5B. The U2N discovery request 532 may be transmitted by the remote UE 508 and received by one or more of the donor UE 504, the first intermediate relay UE 505, and/or the second intermediate relay UE 506. Alternatively (e.g., for Model A U2N relay discovery), the remote UE 508 may not make a request (e.g., the U2N discovery request 532 may be omitted) and may instead monitor for an announcement from potential relay UEs (e.g., relay UE candidates). As shown in FIG. 5A, each relay UE that receives an announcement message (e.g., which may be referred to as a discovery message) may increment a hop count for the message. For example, if an announcement message (e.g., discovery message 516) has a hop count of 1, the relay UE 505 may increment the hop count, at 518, to a hop count of 2 before transmitting the announcement message (e.g., discovery message 520). The relay UE 506 receives the announcement message with a hop count of 2, increments the hop count to 3, at 522, and transmits the announcement message (e.g., discovery message 524) with a hop count of 3.

FIG. 5B illustrates an example based on Model B discovery, e.g., in which a discoverer UE provides a query or request, and the discoveree UE responds with a response message (e.g., which may be referred to as a request and a response message). The request and/or response messages may also be referred to as discovery messages. For example, the remote UE 508 transmits a request 532 to the relay UE 506. The request 532 may indicate a hop count of 1. At 534, the relay UE 506 increments the hop count before transmitting the discovery request 536 to the relay UE 505 based on the request 532. The hop count in the request 536 is 2. At 538, the relay UE 505 increments the hop count before transmitting the discovery request 540 to the donor UE 504 based on the request 534. The hop count in the request 540 is 3. Based on receiving the U2N discovery request 540, the donor UE 504 may reply, or announce, its availability to act as a relay UE by transmitting U2N response/announcement (e.g., discovery message 544). The announcement (e.g., which may be referred to as a discovery message) may include or indicate an RSC, relay user information, and/or a hop count. The U2N reply/announcement (e.g., 544) may include an indication (e.g., a hop count equal to one) that the donor UE 504 represents a single-hop path to a network (e.g., a base station). The discovery message 516 (in FIG. 5A and/or FIG. 5B), in some aspects, may have integrity protection (configured based on the relay discovery security materials 512) to avoid path length manipulation by an attacker. In some aspects, the message 544 may be associated with an emergency service and the integrity protection may use a null integrity protection algorithm (e.g., which may be referred to as being without integrity protection). The message 544 may be received by the first intermediate relay UE 505 and the first intermediate relay UE 505 may, at 546, verify the integrity of the message, increment the hop count, and apply integrity protection. The first intermediate relay UE 505 may transmit a U2N reply/announcement (e.g., discovery message 520) that may be received at the second intermediate relay UE 506 and/or at the remote UE 508. The discovery message may include or indicate an RSC, relay user information, and/or an incremented hop count. The relay UE 505 may increment the hop count at 546. The U2N reply/announcement (e.g., discovery message 548) may include an indication (e.g., a hop count equal to two) that the first intermediate relay UE 505 represents a multiple-hop path to a network (e.g., a base station) including two hops. Based on receiving the U2N discovery message (e.g., 548), the second intermediate relay UE 506 may, at 552, verify the integrity of the message, increment the hop count (e.g., from 2 to 3), and apply integrity protection before transmitting (or forwarding) the discovery message. The second intermediate relay UE 506 may then transmit, and the remote UE 508 may receive, the discovery message 554. The discovery message may include or indicate an RSC, relay user information, and/or a hop count (e.g., 3). The discovery message 554 may include an indication (e.g., a hop count equal to three hops between the remote UE 508 and the donor UE) that the second intermediate relay UE 506 represents a multiple-hop path to a network (e.g., a base station) including three hops.

Upon receiving one or more U2N discovery responses and/or announcements (e.g., 524 or 554), the remote UE 508 may verify the integrity of the message and select a multi-hop path and an associated relay UE at 526 or 556. In some aspects, the U2N discovery message 524 or 556 may be associated with an emergency service and the integrity protection may use a null integrity protection algorithm (e.g., be without integrity protection). The selection may be based on multiple factors and/or criteria including the number of hops associated with each multi-hop path. After selecting a multi-hop path at 526 or 556, the remote UE 508 and the donor UE 504 (along with any of the first intermediate relay UE 505 and the second intermediate relay UE 506 along the multi-hop path) may establish a secure U2N relay at 528 or 558. As an example, the remote UE 508 may establish an end-to-end Uu connection setup with security (e.g., for L2) with the network via the multiple relays.

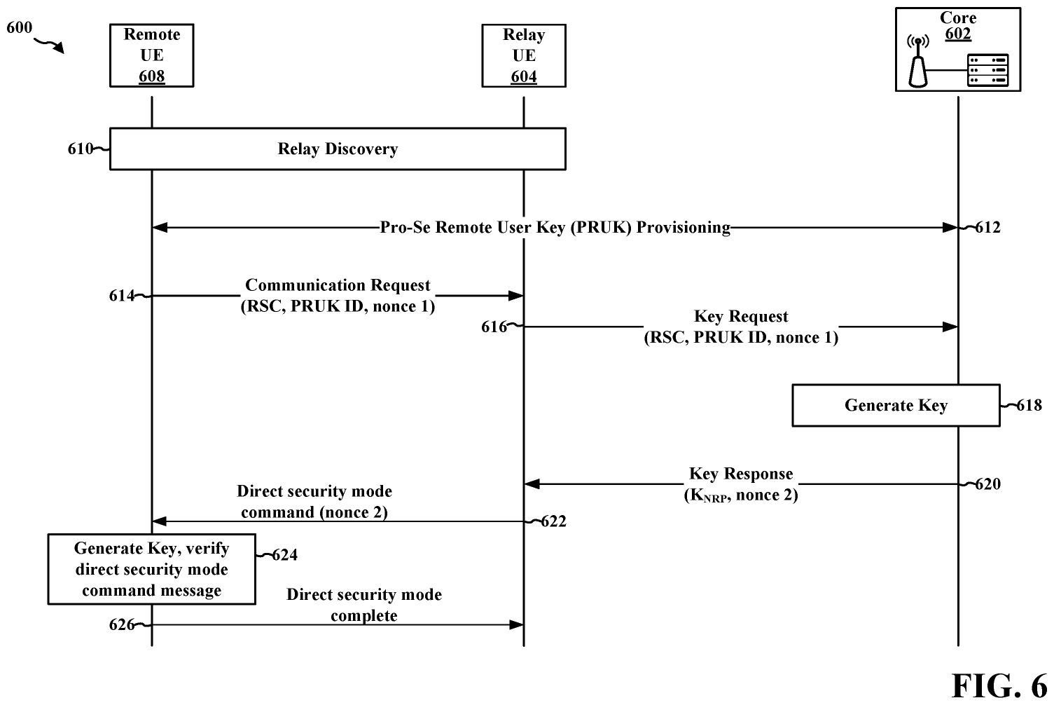

FIG. 6 is a call flow diagram illustrating a method associated with a user plane-based security procedure for a single hop U2N relay in accordance with some aspects of the disclosure. Call flow diagram 600 illustrates a set of elements associated with a core network 602, a relay UE 604 and a remote UE 608. The method is illustrated in relation to a core network 602 (e.g., as an example of a network device or network node and associated elements of a core network that may include one or more components of a disaggregated base station) in communication with the relay UE 604 and the remote UE 608 (e.g., as examples of wireless devices). The functions ascribed to the core network 602, in some aspects, may be performed by one or more components of a core network, a network entity, a network node, or a network device (a single network entity/node/device or a disaggregated network entity/node/device as described above in relation to FIG. 1 or an element of a core network as described above in relation to FIG. 4). Similarly, the functions ascribed to the UEs (e.g., the relay UE 604 and the remote UE 608), in some aspects, may be performed by one or more components of a wireless device supporting communication with a network entity/node/device. Accordingly, references to “transmitting” in the description below may be understood to refer to a first component of the core network 602 (or a UE) outputting (or providing) an indication of the content of the transmission to be transmitted by a different component of the core network 602 (or the UE). Similarly, references to “receiving” in the description below may be understood to refer to a first component of the core network 602 (or the UE) receiving a transmitted signal and outputting (or providing) the received signal (or information based on the received signal) to a different component of the core network 602 (or the UE).

At 610, the remote UE 608 and the relay UE 604 may participate in a relay discovery procedure. After discovering the relay UE 604, the remote UE 608 may, in association with ProSe remote user key (PRUK) provisioning, exchange one or more provisioning messages 612 with the core network 602. Based on the PRUK provisioning associated with the one or more provisioning messages 612, the remote UE 608 may transmit, and the relay UE 604 may receive, a communication request 614. The communication request 614, in some aspects, may include a relay service code (RSC) value, a PRUK identifier (ID) and a first nonce. Based on the communication request 614, the relay UE 604 may transmit, and the core network 602 (a PKMF or a ProSe anchor function of the core network 602) may receive, a key request 616. The key request 616, in some aspects, may include the RSC value, the PRUK ID, and a first nonce.

Based on the key request 616, the core network 602 may generate, at 618, a key. The core network 602 may transmit, and the relay UE 604 may receive, a key response 620. The key response 620, in some aspects, may include a key (e.g., K_{NRP}) based on the PRUK, the first nonce and a second nonce. Based on the key (e.g., the K_{NRP}) associated with the key response 620, the relay UE 604 may transmit, and the remote UE 608 may receive, the direct security mode command 622. The direct security mode command 622 may include a second nonce. Upon receipt of the direct security mode command message, the remote UE 608 may generate the key (e.g., the K_{NRP}) and verify the direct security mode command message, as shown at 624. The Remote UE 608 may transmit, and the relay UE 604 may receive, a direct security mode complete message 626 indicating a successful key generation and the message verification.

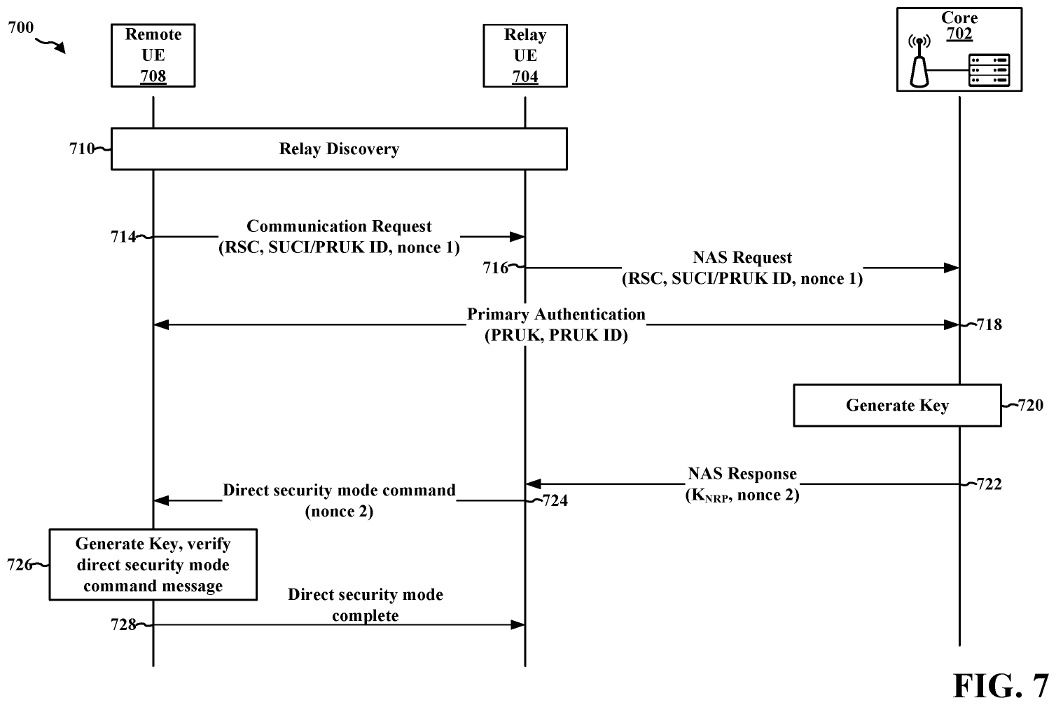

FIG. 7 is a call flow diagram illustrating a method associated with a control plane-based security procedure for a single hop U2N relay in accordance with some aspects of the disclosure. Call flow diagram 700 illustrates a set of elements associated with a core network 702, a relay UE 704 and a remote UE 708. The method is illustrated in relation to a core network 702 (e.g., as an example of a network device or network node and associated elements of a core network that may include one or more components of a disaggregated base station) in communication with the relay UE 704 and the remote UE 708 (e.g., as examples of wireless devices). The functions ascribed to the core network 702, in some aspects, may be performed by one or more components of a core network, a network entity, a network node, or a network device (a single network entity/node/device or a disaggregated network entity/node/device as described above in relation to FIG. 1 or an element of a core network as described above in relation to FIG. 4). Similarly, the functions ascribed to the UEs (e.g., the relay UE 704 and the remote UE 708), in some aspects, may be performed by one or more components of a wireless device supporting communication with a network entity/node/device. Accordingly, references to “transmitting” in the description below may be understood to refer to a first component of the core network 702 (or a UE) outputting (or providing) an indication of the content of the transmission to be transmitted by a different component of the core network 702 (or the UE). Similarly, references to “receiving” in the description below may be understood to refer to a first component of the core network 702 (or the UE) receiving a transmitted signal and outputting (or providing) the received signal (or information based on the received signal) to a different component of the core network 702 (or the UE).

At 710, the remote UE 708 and the relay UE 704 may participate in a relay discovery procedure. Based on the relay discovery procedure at 710, the remote UE 708 may transmit, and the relay UE 704 may receive, a communication request 714. The communication request 714, in some aspects, may include an RSC value, a subscription concealed ID (SUCI), or a PRUK ID, and a first nonce. Based on the communication request 714, the relay UE 704 may transmit, and the core network 702 (an AMF and/or an authentication server function (AUSF) of the core network 702 associated with the relay UE 704) may receive, a non-access stratum (NAS) request 716. The NAS request 716, in some aspects, may include the RSC, the SUCI or the PRUK ID, and the first nonce.

In some aspects, when a PRUK ID is not provided, the remote UE 708 may in association with a primary authentication, exchange one or more primary authentication messages 718 with the core network 702 (e.g., a home public land mobile network (HPLMN) of the core network 702 associated with the remote UE 708) to derive a PRUK and PRUK ID. In some aspects, the one or more primary authentication messages 718 may include or be associated with storing the PRUK and the PRUK ID at a ProSe anchor function of the core network 702. Based on the PRUK, the core network 702 may generate, at 720, a key (e.g., K_{NRP}) based on the PRUK, the first nonce and a second nonce. In response to the NAS request 716, the core network 702 may transmit, and the relay UE 704 may receive, NAS response 722 including the key (e.g., the K_{NRP}) generated at 720 and the second nonce used to generate the key. To establish a secure link, the relay UE 704 may transmit, and the remote UE 708 may receive, a security message 724 including the second nonce. As described in connection with 622, 624, and 626 in FIG. 6, the remote UE 708 may generate a key at 726 based on the PRUK and the second nonce (that was received in the security message 724, to verify the security message 724. The remote UE 708 and the relay UE 704 may exchange additional messages and perform additional operations to establish a secure link based on the security message and/or the keys provided to the remote UE 708 and the relay UE 704. For example, as shown at 728, the remote UE 708 may transmit a message to the relay UE 704 indicating a response to the security message 724, such as a complete message.

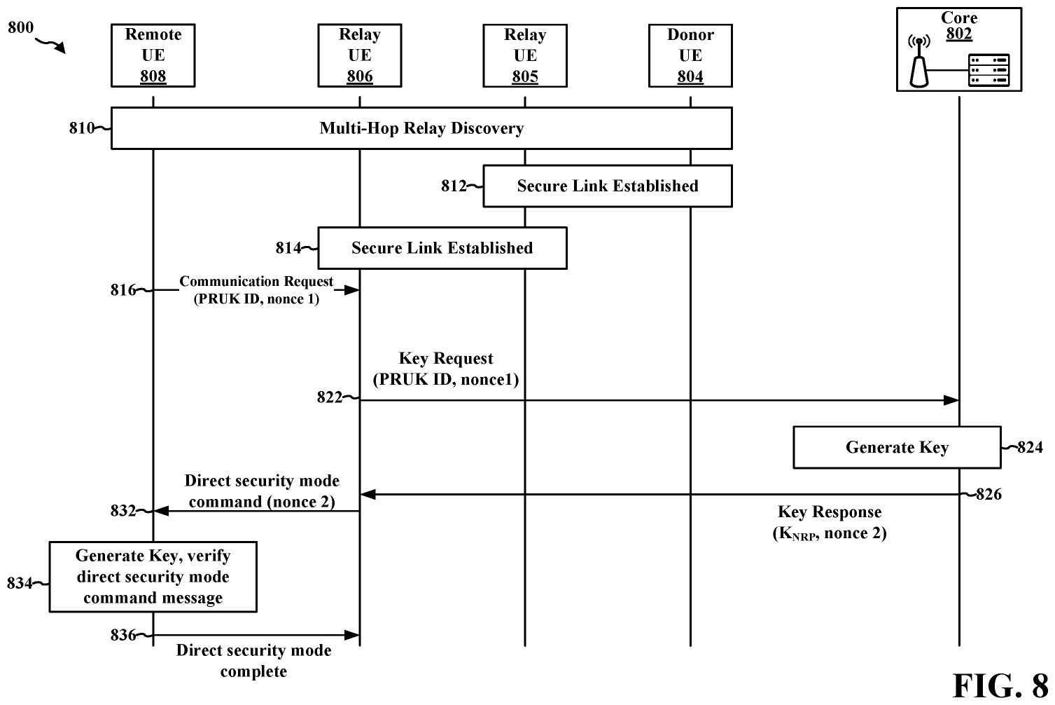

FIG. 8 is a call flow diagram illustrating a method associated with a user plane-based security procedure for a multiple hop U2N relay in accordance with some aspects of the disclosure. Call flow diagram 800 illustrates a set of elements associated with a core network 802, a donor UE 804 (e.g., a first relay UE or donor U2N relay UE), a first intermediate relay UE 805 (e.g., a first intermediate U2N relay UE), a second intermediate relay UE 806 (e.g., a second intermediate U2N relay UE), and a remote UE 808.

The method is illustrated in relation to a core network 802 (e.g., as an example of a network device or network node and associated elements of a core network that may include one or more components of a disaggregated base station) in communication with at least the donor UE 804, the first intermediate relay UE 805, the second intermediate relay UE 806, and the remote UE 808 (e.g., as examples of wireless devices). The functions ascribed to the core network 802, in some aspects, may be performed by one or more components of a core network, a network entity, a network node, or a network device (a single network entity/node/device or a disaggregated network entity/node/device as described above in relation to FIG. 1 or an element of a core network as described above in relation to FIG. 4). Similarly, the functions ascribed to the UEs (e.g., the donor UE 804, the first intermediate relay UE 805, the second intermediate relay UE 806, and the remote UE 808), in some aspects, may be performed by one or more components of a wireless device supporting communication with a network entity/node/device. Accordingly, references to “transmitting” in the description below may be understood to refer to a first component of the core network 802 (or a UE) outputting (or providing) an indication of the content of the transmission to be transmitted by a different component of the core network 802 (or the UE). Similarly, references to “receiving” in the description below may be understood to refer to a first component of the core network 802 (or the UE) receiving a transmitted signal and outputting (or providing) the received signal (or information based on the received signal) to a different component of the core network 802 (or the UE).

At 810, the donor UE 804, the first intermediate relay UE 805, the second intermediate relay UE 806, and the remote UE 808 may participate in a multi-hop relay discovery procedure. After discovering one or more relay UEs (e.g., the second intermediate relay UE 806), the remote UE 808 may obtain a PRUK and a PRUK ID as described in relation to the one or more provisioning messages 612 of FIG. 6. Based on the multi-hop relay discovery, the first intermediate relay UE 805 at 812 may establish a secure link with the donor UE 804, and the second intermediate relay UE 806 may establish a secure link with the first intermediate relay UE 805 at 814. In some aspects, the secure link between the first intermediate relay UE 805 and the donor UE 804 may be established at 812 as described in relation to FIG. 6 and the secure link between the second intermediate relay UE 806 and the first intermediate relay UE 805 may similarly be established at 814 as described in relation to FIG. 6 (using the first intermediate relay UE 805 and the donor UE 804 to communicate with (or access) the core network 802).

The remote UE 808 may transmit, and the second intermediate relay UE 806 may receive, a communication request 816. The communication request 816, in some aspects, may include an RSC value, a PRUK ID, and the first nonce. Based on the communication request 816, the second intermediate relay UE 806 may transmit, and the core network 802 (a PKMF or a ProSe anchor function of the core network 802) may receive, a key request 822. The key request 822, in some aspects, may include the RSC value, the PRUK ID (based on the first nonce), and the first nonce.

Based on the key request 822, the core network 802 may generate, at 824, a key. The core network 802 may transmit, and the second intermediate relay UE 806 may receive, a key response 826. The key response 826, in some aspects, may include a key (e.g., K_{NRP}) based on the PRUK, the first nonce and a second nonce. To establish a secure link, the second intermediate relay UE 806 may transmit, and the remote UE 808 may receive, a direct security mode command message 832 including the second nonce, and the additional value used to generate the third key. As described in connection with FIGS. 6 and 7, at 834, the remote UE 808 may generate the key based on the PRUK, the first nonce, the second nonce to verify the direct security mode command message 832. The remote UE 808 may transmit, and the second intermediate relay UE 806 may receive, a direct security mode complete message 836 to establish a secure link based on the key. As described in relation to FIG. 8, the method establishes a series of hop-to-hop secure connections that may be used to provide network access to the remote UE 808 as a multiple-hop U2N relay.

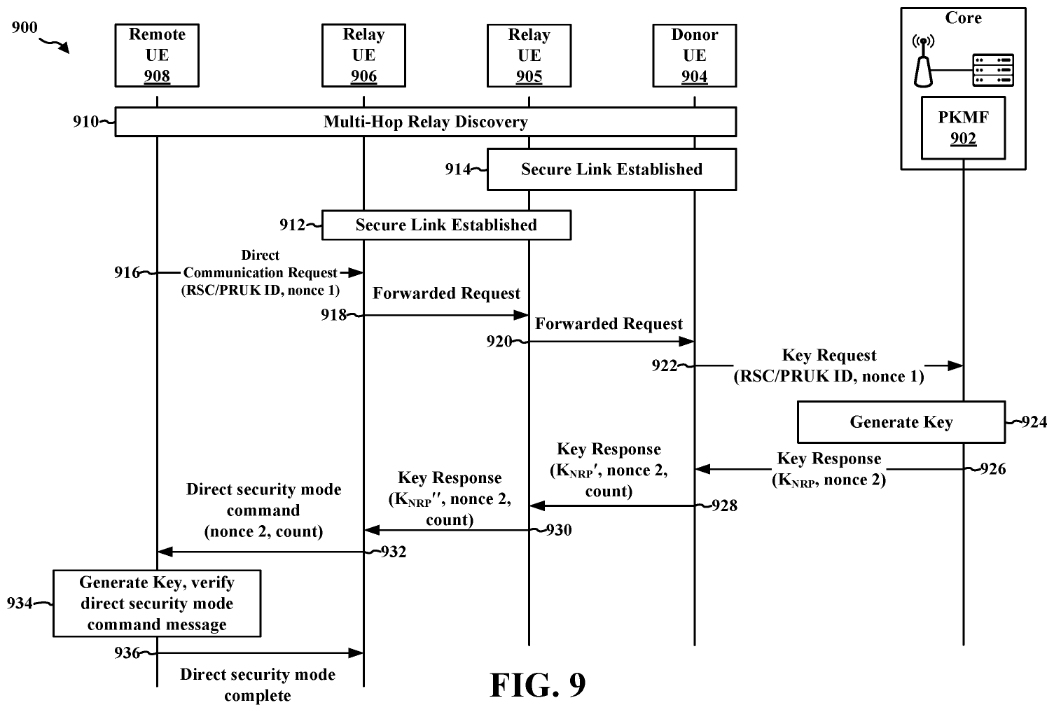

FIG. 9 is a call flow diagram 900 illustrating a method associated with a user plane-based security procedure for a multiple-hop U2N relay in accordance with some aspects of the disclosure. In some aspects, the UP based security procedure in FIG. 8 may be referred to as a first mode, and the UP based security procedure in FIG. 9 may be referred to as a second mode. In some aspects, a network entity (e.g., such as a PKMF or a DDNMF) may configure, provision, or otherwise indicate the mode to be used for security procedures, e.g., indicating a first mode that includes aspects described in connection with FIG. 8 or a second mode that includes aspects described in connection with FIG. 9. Call flow diagram 900 illustrates a set of elements associated with a core network 902, a donor UE 904 (e.g., a first relay UE or donor U2N relay UE), a first intermediate relay UE 905 (e.g., a first intermediate U2N relay UE), a second intermediate relay UE 906 (e.g., a second intermediate U2N relay UE), and a remote UE 908.

The method is illustrated in relation to a core network 902 (e.g., as an example of a network device or network node and associated elements of a core network that may include one or more components of a disaggregated base station) in communication with at least the donor UE 904, the first intermediate relay UE 905, the second intermediate relay UE 906, and the remote UE 908 (e.g., as examples of wireless devices). The functions ascribed to the core network 902, in some aspects, may be performed by one or more components of a core network, a network entity, a network node, or a network device (a single network entity/node/device or a disaggregated network entity/node/device as described above in relation to FIG. 1 or an element of a core network as described above in relation to FIG. 4). Similarly, the functions ascribed to the UEs (e.g., the donor UE 904, the first intermediate relay UE 905, the second intermediate relay UE 906, and the remote UE 908), in some aspects, may be performed by one or more components of a wireless device supporting communication with a network entity/node/device. Accordingly, references to “transmitting” in the description below may be understood to refer to a first component of the core network 902 (or a UE) outputting (or providing) an indication of the content of the transmission to be transmitted by a different component of the core network 902 (or the UE). Similarly, references to “receiving” in the description below may be understood to refer to a first component of the core network 902 (or the UE) receiving a transmitted signal and outputting (or providing) the received signal (or information based on the received signal) to a different component of the core network 902 (or the UE).

At 910, the donor UE 904, the first intermediate relay UE 905, the second intermediate relay UE 906, and the remote UE 908 may participate in a multi-hop relay discovery procedure. Based on the multi-hop relay discovery the second intermediate relay UE 906 may establish a secure link with the first intermediate relay UE 905 at 912, and the first intermediate relay UE 905 may establish a secure link with the donor UE 904. In some aspects, the secure link between the first intermediate relay UE 905 and the donor UE 904 may be established at 914 as described in relation to FIG. 7 and the secure link between the second intermediate relay UE 906 and the first intermediate relay UE 905 may similarly be established at 912 as described in relation to FIG. 7 (using the first intermediate relay UE 905 and the donor UE 904 to communicate with (or access) the core network 902).

Based on the relay discovery procedure at 910, the remote UE 908 may transmit, and the second intermediate relay UE 906 may receive, a communication request 916. The communication request 916, in some aspects, may include an RSC value, a PRUK ID, and the first nonce. Based on the communication request 916, the second intermediate relay UE 906 may forward, and the first intermediate relay UE 905 may receive, the forwarded request 918 including the RSC value, the PRUK ID, and the first nonce. The first intermediate relay UE 905 may forward, and the donor UE 904 may receive, the forwarded request 920 including the RSC value, the PRUK ID, and the first nonce. Based on the communication request 914, the relay UE 904 may transmit, and the core network 902 (e.g., key management network entity (PKMF)) may receive, a key request 922. The Key request 922, in some aspects, may include the RSC value, the PRUK ID, and the first nonce.

Based on the key request, the core network 902 may generate, at 924, a key. The key management network entity (e.g., of the core network 902) may transmit, and the donor UE 904 may receive, a key response 926. The key response 926, in some aspects, may include a first key (e.g., K_{NRP}) based on the PRUK and a second nonce. The donor UE 904 may generate a second key (e.g., K_{NRP}′) based on the first key and transmit, and the first intermediate relay UE 905 may receive, a key response 928 including the second key based on the first key (e.g., K_{NRP}′ based on the K_{NRP} and an additional value such as a key derivation count or a relay UE ID), the second nonce, and the additional value used to generate the second key. As an example, If K_{NRP} is shared, then the donor UE 904 sets the key derivation count as 0, for example. If K_{NRP}′ is provided, then the donor UE 904 sets the key derivation count as 1. On receiving the key response from the donor UE 904, if the relay UE 905 derives K_{NRP}″, then the relay UE 905 increments the key derivation count to 2. By checking the key derivation count in the direct security mode command, the remote UE may determine how to derive the same key. The first intermediate relay UE 905 may generate a third key (e.g., K_{NRP}″) based on the second key and transmit, and the second intermediate relay UE 906 may receive, the key response 930 including the third key based on the second key (e.g., K_{NRP}″ based on the K_{NRP}′ and an additional value such as a key derivation count or a relay UE ID), the second nonce, and the additional value used to generate the third key. As described in connection with FIGS. 6, 7, 8, and 10, to establish a secure link, the second intermediate relay UE 906 may transmit, and the remote UE 908 may receive, a direct security mode command message 932 including the second nonce, and the additional value used to generate the third key. At 934, the remote UE 908 may generate the third key (e.g., K_{NRP}″) based on the PRUK, the first nonce, the second nonce, and the additional value used to generate the third key to verify the direct security mode command message 932. The remote UE 908 may transmit, and the second intermediate relay UE 906 may receive, a direct security mode complete message 936 to establish a secure link based on the third key.

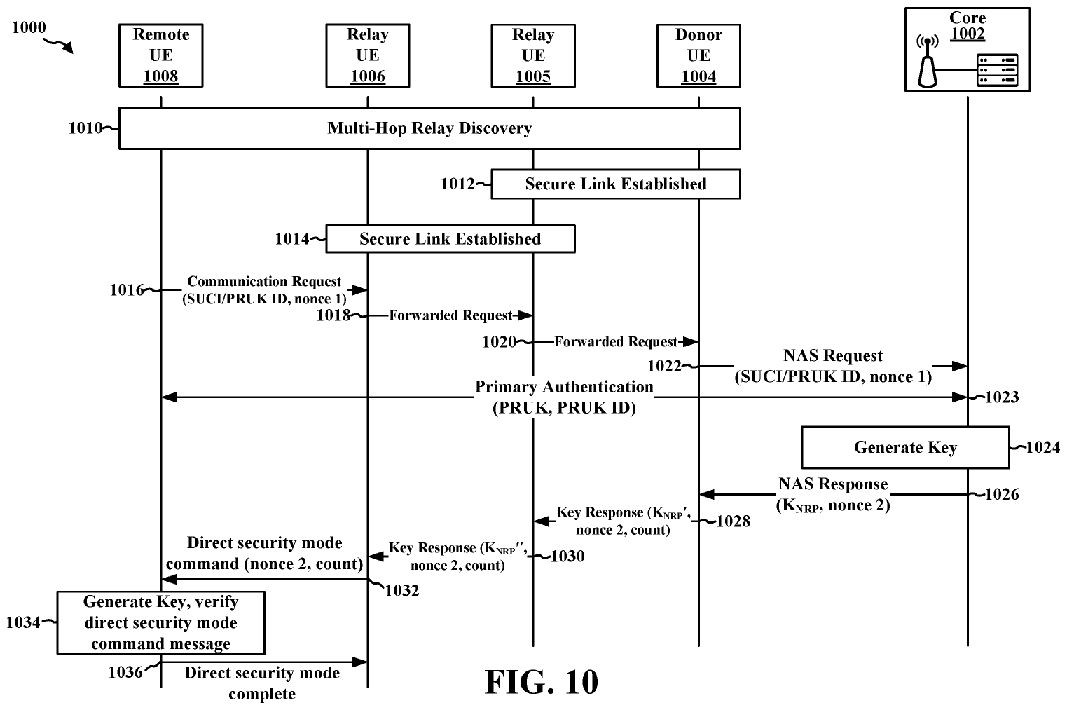

FIG. 10 is a call flow diagram illustrating a method associated with a control plane-based security procedure for a multiple-hop U2N relay in accordance with some aspects of the disclosure. Call flow diagram 1000 illustrates a set of elements associated with a core network 1002, a donor UE 1004 (e.g., a first relay UE or donor U2N relay UE), a first intermediate relay UE 1005 (e.g., a first intermediate U2N relay UE), a second intermediate relay UE 1006 (e.g., a second intermediate U2N relay UE), and a remote UE 1008.

The method is illustrated in relation to a core network 1002 (e.g., as an example of a network device or network node and associated elements of a core network that may include one or more components of a disaggregated base station) in communication with at least the donor UE 1004, the first intermediate relay UE 1005, the second intermediate relay UE 1006, and the remote UE 1008 (e.g., as examples of wireless devices). The functions ascribed to the core network 1002, in some aspects, may be performed by one or more components of a core network, a network entity, a network node, or a network device (a single network entity/node/device or a disaggregated network entity/node/device as described above in relation to FIG. 1 or an element of a core network as described above in relation to FIG. 4). Similarly, the functions ascribed to the UEs (e.g., the donor UE 1004, the first intermediate relay UE 1005, the second intermediate relay UE 1006, and the remote UE 1008), in some aspects, may be performed by one or more components of a wireless device supporting communication with a network entity/node/device. Accordingly, references to “transmitting” in the description below may be understood to refer to a first component of the core network 1002 (or a UE) outputting (or providing) an indication of the content of the transmission to be transmitted by a different component of the core network 1002 (or the UE). Similarly, references to “receiving” in the description below may be understood to refer to a first component of the core network 1002 (or the UE) receiving a transmitted signal and outputting (or providing) the received signal (or information based on the received signal) to a different component of the core network 1002 (or the UE).

At 1010, the donor UE 1004, the first intermediate relay UE 1005, the second intermediate relay UE 1006, and the remote UE 1008 may participate in a multi-hop relay discovery procedure. Based on the multi-hop relay discovery the second intermediate relay UE 1006 may establish a secure link with the first intermediate relay UE 1005 at 1014, and the first intermediate relay UE 1005 may establish a secure link with the donor UE 1004 at 1012. In some aspects, the secure link between the first intermediate relay UE 1005 and the donor UE 1004 may be established at 1012 as described in relation to FIG. 7 and the secure link between the second intermediate relay UE 1006 and the first intermediate relay UE 1005 may similarly be established at 1014 as described in relation to FIG. 7 (using the first intermediate relay UE 1005 and the donor UE 1004 to communicate with (or access) the core network 1002).

Based on the relay discovery procedure at 1010, the remote UE 1008 may transmit, and the second intermediate relay UE 1006 may receive, a direct communication request 1016. The direct communication request 1016, in some aspects, may include an RSC value, a SUCI, or a PRUK ID and a first nonce. Based on the direct communication request 1016, the second intermediate relay UE 1006 may forward, and the first intermediate relay UE 1005 may receive, the forwarded request 1018 including the RSC value, the SUCI or the PRUK ID, and the first nonce. The first intermediate relay UE 1005 may forward, and the donor UE 1004 may receive, the forwarded request 1020 including the RSC value, the SUCI or the PRUK ID, and the first nonce. Based on the communication request 1014, the relay UE 1004 may transmit, and the core network 1002 (an AMF and/or an AUSF of the core network 1002 associated with the donor UE 1004) may receive, a NAS request 1022. The NAS request 1022, in some aspects, may include the RSC value, the SUCI or the PRUK ID, and the first nonce.

In some aspects, when a PRUK ID is not provided, the remote UE 1008 may in association with a primary authentication, exchange one or more primary authentication messages 1023 with the core network 1002 (e.g., an HPLMN of the core network 1002 associated with the remote UE 1008) to receive a PRUK and PRUK ID. In some aspects, the one or more primary authentication messages 1023 may include or be associated with storing the PRUK and the PRUK ID at a ProSe anchor function of the core network 1002.

Based on the key request (e.g., NAS request 1022), the core network 1002 may generate, at 1024, a key. The core network 1002 may transmit, and the donor UE 1004 may receive, a NAS response 1026. The NAS response 1026, in some aspects, may include a first key (e.g., K_{NRP}) based on the PRUK and a second nonce. The donor UE 1004 may generate a second key (e.g., K_{NRP}′) based on the first key and transmit, and the first intermediate relay UE 1005 may receive, a key response 1028 including the second key based on the first key (e.g., K_{NRP}′ based on the K_{NRP} and an additional value such as a hop count or a relay UE ID), the second nonce, and the additional value used to generate the second key. The first intermediate relay UE 1005 may generate a third key (e.g., K_{NRP}″) based on the second key and transmit, and the second intermediate relay UE 1006 may receive, the key response 1030 including the third key based on the second key (e.g., K_{NRP}″ based on the K_{NRP}′ and an additional value such as a hop count or a relay UE ID), the second nonce, and the additional value used to generate the third key. As described in connection with FIGS. 6, 7, 8 and 9, to establish a secure link, the second intermediate relay UE 1006 may transmit, and the remote UE 1008 may receive, a direct security mode command message 1032 including the second nonce, and the additional value used to generate the third key. At 1034, the remote UE 1008 may generate the third key based on the PRUK, the first nonce, the second nonce, and the additional value used to generate the third key to verify the direct security mode command message 1032. The remote UE 1008 may transmit, and the second intermediate relay UE 1006 may receive, a direct security mode complete message 1036 to establish a secure link based on the third key.

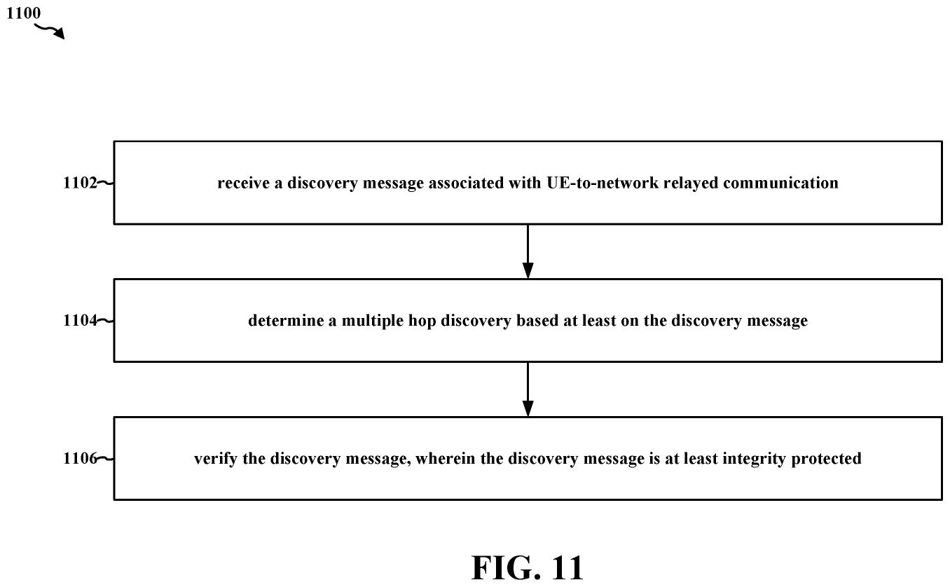

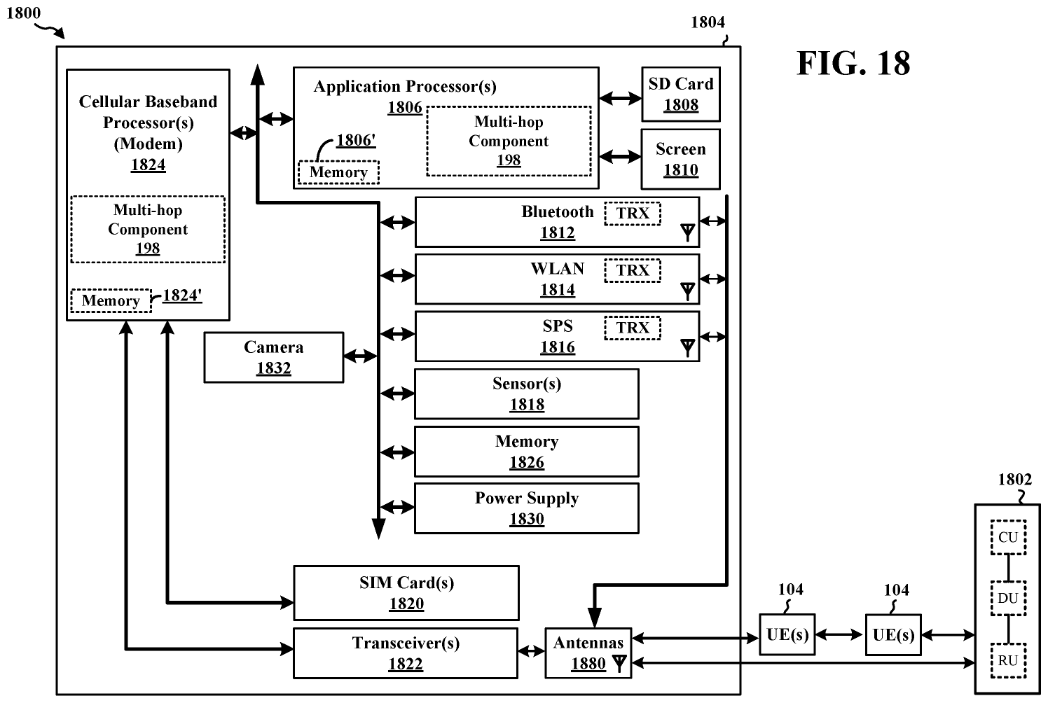

FIG. 11 is a flowchart 1100 of a method of wireless communication. The method may be performed by a wireless device such as a remote UE (e.g., the UE 104, 350, 405, 406, 508, 608, 708, 808, 1008; the apparatus 1804). At 1102, the remote UE may receive a discovery message associated with UE-to-network relayed communication (a U2N relay discovery message). For example, 1102 may be performed by application processor(s) 1806, cellular baseband processor(s) 1824, transceiver(s) 1822, antenna(s) 1880, and/or multi-hop component 198 of FIG. 18. In some aspects, the discovery message may be a discovery announcement message, a discovery response message, or a discovery request message. The discovery message further, in some aspects, may include hop count information for the multiple hop discovery. For example, referring to FIGS. 5A and 5B, the remote UE 508 may receive U2N reply/announcement (e.g., discovery message 524) including a hop count as part of a discovery procedure.

At 1104, the remote UE may determine a multiple hop discovery based at least on the discovery message. For example, 1104 may be performed by application processor(s) 1806, cellular baseband processor(s) 1824, transceiver(s) 1822, antenna(s) 1880, and/or multi-hop component 198 of FIG. 18. In some aspects, the determination may be based on a hop count included in the discovery message. For example, referring to FIGS. 5A and 5B, the remote UE 508 may select a multi-hop path and an associated relay UE at 526 based on the U2N reply/announcement (e.g., discovery message 524). At 1106, the remote UE may verify the discovery message. For example, 1106 may be performed by application processor(s) 1806, cellular baseband processor(s) 1824, transceiver(s) 1822, antenna(s) 1880, and/or multi-hop component 198 of FIG. 18. In some aspects, the discovery message may be at least integrity protected. The integrity protection, in some aspects, may at least apply to the hop count information included in the discovery message. For example, referring to FIGS. 5A and 5B, the remote UE 508 may verify the integrity of the message.

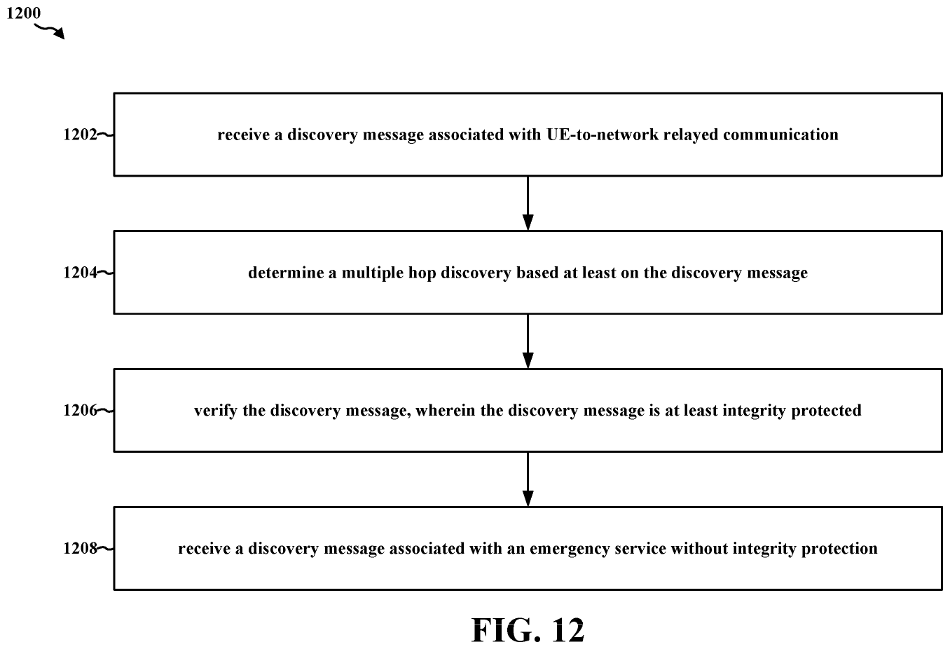

FIG. 12 is a flowchart 1200 of a method of wireless communication. The method may be performed by a wireless device such as a remote UE (e.g., the UE 104, 405, 406; the remote UE 508, 808, 1008; the apparatus 1804). At 1202, the remote UE may receive a discovery message associated with UE-to-network relayed communication (a U2N relay discovery message). For example, 1202 may be performed by application processor(s) 1806, cellular baseband processor(s) 1824, transceiver(s) 1822, antenna(s) 1880, and/or multi-hop component 198 of FIG. 18. In some aspects, the discovery message may be a discovery announcement message, a discovery response message, or a discovery request message. The discovery message further, in some aspects, may include hop count information for the multiple hop discovery. For example, referring to FIG. 5A or FIG. 5B, the remote UE 508 may receive U2N reply/announcement (e.g., discovery message 524) including a hop count as part of a discovery procedure.

At 1204, the remote UE may determine a multiple hop discovery based at least on the discovery message. For example, 1204 may be performed by application processor(s) 1806, cellular baseband processor(s) 1824, transceiver(s) 1822, antenna(s) 1880, and/or multi-hop component 198 of FIG. 18. The determination that the discovery message is associated with a multiple-hop U2N relay may be based on the inclusion of the hop count in the discovery message. In some aspects, the determination may be based on a hop count included in the discovery message. For example, referring to FIG. 5A or 5B, the remote UE 508 may receive the U2N reply/announcement (e.g., discovery message 524) that may be identified as a multi-hop U2N relay discovery message and select a multi-hop path and an associated relay UE at 526 based on the U2N reply/announcement (e.g., discovery message 524).

At 1206, the remote UE may verify the discovery message. For example, 1206 may be performed by application processor(s) 1806, cellular baseband processor(s) 1824, transceiver(s) 1822, antenna(s) 1880, and/or multi-hop component 198 of FIG. 18. In some aspects, the discovery message may be at least integrity protected. The integrity protection, in some aspects, may at least apply to the hop count information included in the discovery message. For example, referring to FIG. 5A or 5B, the remote UE 508 may verify the integrity of the message.

At 1208, the remote UE may receive an additional discovery message associated with an emergency service without integrity protection. For example, 1208 may be performed by application processor(s) 1806, cellular baseband processor(s) 1824, transceiver(s) 1822, antenna(s) 1880, and/or multi-hop component 198 of FIG. 18. In some aspects, the integrity protection for the discovery message uses a null integrity protection algorithm. For example, referring to FIG. 5A or 5B, the remote UE 508 may receive the U2N reply/announcement (e.g., discovery message 524) associated with an emergency service and the integrity protection may use a null integrity protection algorithm (e.g., be without integrity protection).

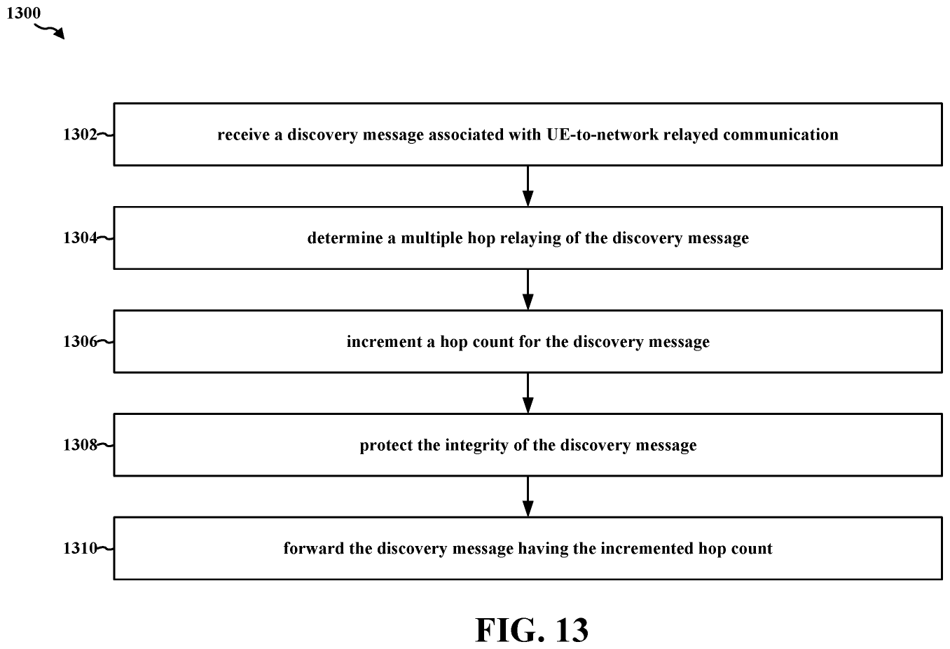

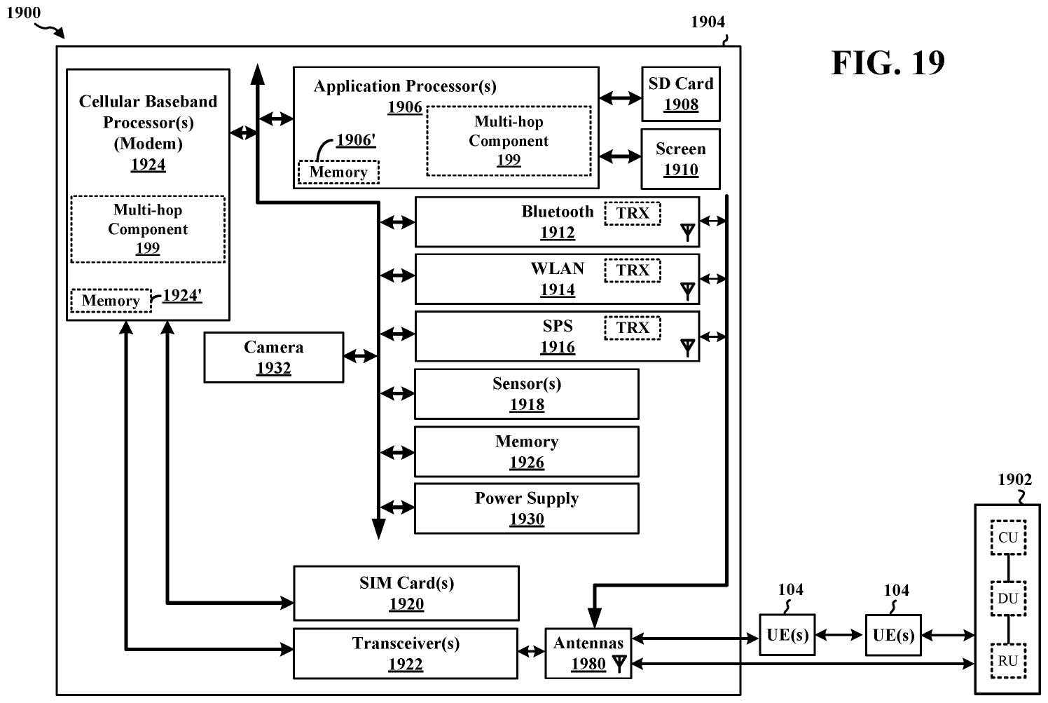

FIG. 13 is a flowchart 1300 of a method of wireless communication. The method may be performed by a wireless device such as a relay UE (e.g., the UE 104, 405, 406; the first intermediate relay UE 505, 805, 1005; the second intermediate relay UE 506, 806, 1006; the donor UE 504, 804, 1004; the apparatus 1904). At 1302, the relay UE may receive a discovery message associated with UE-to-network relayed communication (a U2N relay discovery message). For example, 1302 may be performed by application processor(s) 1906, cellular baseband processor(s) 1924, transceiver(s) 1922, antenna(s) 1980, and/or multi-hop component 199 of FIG. 19. In some aspects, the discovery message may be a discovery announcement message, a discovery response message, or a discovery solicitation message. The discovery message further, in some aspects, may include hop count information for the multiple hop discovery. For example, referring to FIG. 5A or 5B, the first intermediate relay UE 505 (or the second intermediate relay UE 506) may receive U2N reply/announcement (e.g., discovery message 516) or U2N reply/announcement (e.g., discovery message 520) including a hop count as part of a discovery procedure.

At 1304, the relay UE may determine a multiple hop discovery based at least on the discovery message. For example, 1304 may be performed by application processor(s) 1906, cellular baseband processor(s) 1924, transceiver(s) 1922, antenna(s) 1980, and/or multi-hop component 199 of FIG. 19. In some aspects, the discovery message may be at least integrity protected. The determination that the discovery message is associated with a multiple-hop U2N relay may be based on the inclusion of the hop count in the discovery message. In some aspects, the determination may be based on a hop count included in the discovery message. For example, referring to FIG. 5A or 5B, the first intermediate relay UE 505 (or the second intermediate relay UE 506) may receive the U2N reply/announcement (e.g., discovery message 516) or the U2N reply/announcement (e.g., discovery message 520) that may be identified as a multi-hop U2N relay discovery message based on the inclusion of the hop count.

At 1306, the relay UE may increment a hop count for the discovery message. For example, 1306 may be performed by application processor(s) 1906, cellular baseband processor(s) 1924, transceiver(s) 1922, antenna(s) 1980, and/or multi-hop component 199 of FIG. 19. In some aspects, the relay UE may verify the integrity of the discovery message before incrementing the hop count (where the hop count is also protected by the integrity protection). For example, referring to FIG. 5A or 5B, the first intermediate relay UE 505 (or the second intermediate relay UE 506) may increment the hop count at 518 (or at 522).

At 1308, the relay UE may protect the integrity of the discovery message. For example, 1308 may be performed by application processor(s) 1906, cellular baseband processor(s) 1924, transceiver(s) 1922, antenna(s) 1980, and/or multi-hop component 199 of FIG. 19. In some aspects, the integrity protection for the discovery message uses a null integrity protection algorithm. For example, referring to FIG. 5A or 5B, the first intermediate relay UE 505 (or the second intermediate relay UE 506) may increment the hop count and apply integrity protection at 518 (or at 522).

At 1310, the relay UE may forward the discovery message having the incremented hop count. For example, 1310 may be performed by application processor(s) 1906, cellular baseband processor(s) 1924, transceiver(s) 1922, antenna(s) 1980, and/or multi-hop component 199 of FIG. 19. The discovery message may be a discovery announcement message, a discovery reply message, or a discovery request message. For example, referring to FIG. 5A or 5B, the first intermediate relay UE 505 (or the second intermediate relay UE 506) may transmit (or forward) the U2N reply/announcement (e.g., discovery message 520) (or the U2N reply/announcement (e.g., discovery message 524)) that include the incremented hop count.

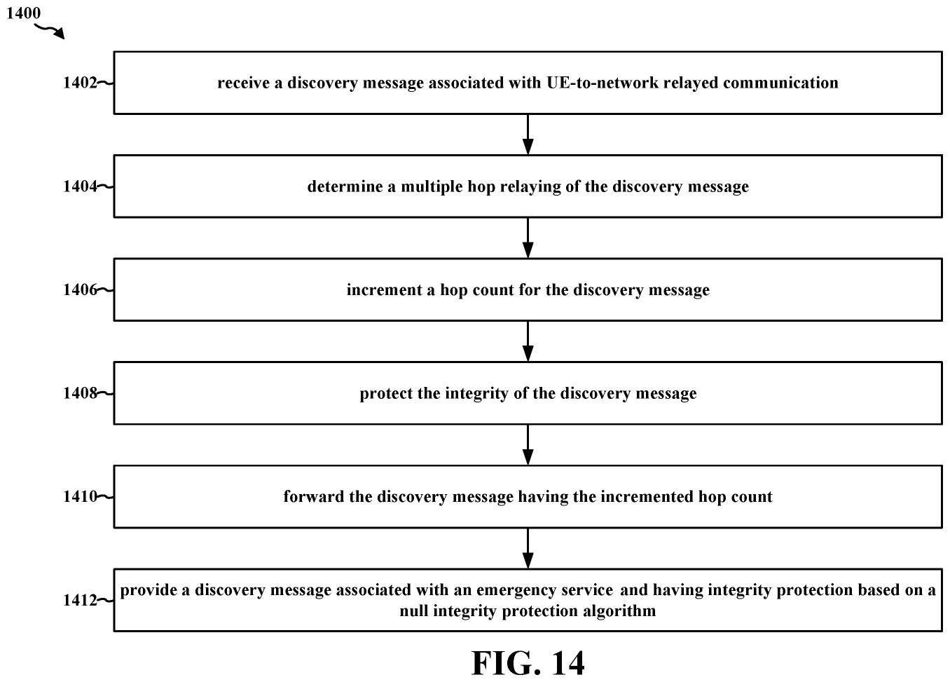

FIG. 14 is a flowchart 1400 of a method of wireless communication. The method may be performed by a wireless device such as a relay UE (e.g., the UE 104, 405, 406; the first intermediate relay UE 505, 805, 1005; the second intermediate relay UE 506, 806, 1006; the donor UE 504, 804, 1004; the apparatus 1904). At 1402, the relay UE may receive a discovery message associated with UE-to-network relayed communication (a U2N relay discovery message). For example, 1402 may be performed by application processor(s) 1906, cellular baseband processor(s) 1924, transceiver(s) 1922, antenna(s) 1980, and/or multi-hop component 199 of FIG. 19. In some aspects, the discovery message may be a discovery announcement message, a discovery response message, or a discovery solicitation message. The discovery message further, in some aspects, may include hop count information for the multiple hop discovery. For example, referring to FIG. 5A or 5B, the first intermediate relay UE 505 (or the second intermediate relay UE 506) may receive U2N reply/announcement (e.g., discovery message 516) or U2N reply/announcement (e.g., discovery message 520) including a hop count as part of a discovery procedure.

At 1404, the relay UE may determine a multiple hop discovery based at least on the discovery message. For example, 1404 may be performed by application processor(s) 1906, cellular baseband processor(s) 1924, transceiver(s) 1922, antenna(s) 1980, and/or multi-hop component 199 of FIG. 19. In some aspects, the discovery message may be at least integrity protected. The determination that the discovery message is associated with a multiple-hop U2N relay may be based on the inclusion of the hop count in the discovery message. In some aspects, the determination may be based on a hop count included in the discovery message. For example, referring to FIG. 5A or 5B, the first intermediate relay UE 505 (or the second intermediate relay UE 506) may receive the U2N reply/announcement (e.g., discovery message 516) or the U2N reply/announcement (e.g., discovery message 520) that may be identified as a multi-hop U2N relay discovery message based on the inclusion of the hop count.

At 1406, the relay UE may increment a hop count for the discovery message. For example, 1406 may be performed by application processor(s) 1906, cellular baseband processor(s) 1924, transceiver(s) 1922, antenna(s) 1980, and/or multi-hop component 199 of FIG. 19. In some aspects, the relay UE may verify the integrity of the discovery message before incrementing the hop count (where the hop count is also protected by the integrity protection). For example, referring to FIG. 5A or 5B, the first intermediate relay UE 505 (or the second intermediate relay UE 506) may increment the hop count at 518 (or at 522).

At 1408, the relay UE may protect the integrity of the discovery message. For example, 1408 may be performed by application processor(s) 1906, cellular baseband processor(s) 1924, transceiver(s) 1922, antenna(s) 1980, and/or multi-hop component 199 of FIG. 19. In some aspects, the integrity protection for the discovery message uses a null integrity protection algorithm. For example, referring to FIG. 5A or 5B, the first intermediate relay UE 505 (or the second intermediate relay UE 506) may increment the hop count and apply integrity protection at 518 (or at 522).

At 1410, the relay UE may forward the discovery message having the incremented hop count. For example, 1410 may be performed by application processor(s) 1906, cellular baseband processor(s) 1924, transceiver(s) 1922, antenna(s) 1980, and/or multi-hop component 199 of FIG. 19. The discovery message may be a discovery announcement message, a discovery reply message, or a discovery request message. For example, referring to FIG. 5A or 5B, the first intermediate relay UE 505 (or the second intermediate relay UE 506) may transmit (or forward) the U2N reply/announcement (e.g., discovery message 520) or the U2N reply/announcement (e.g., discovery message 524) that include the incremented hop count.

At 1412, the relay UE may provide an additional discovery message associated with an emergency service having integrity protection based on a null integrity protection algorithm. For example, 1208 may be performed by application processor(s) 1906, cellular baseband processor(s) 1924, transceiver(s) 1922, antenna(s) 1980, and/or multi-hop component 199 of FIG. 19. In some aspects, the integrity protection for the discovery message uses a null integrity protection algorithm. For example, referring to FIG. 5A or 5B, the first intermediate relay UE 505 (or the second intermediate relay UE 506) may transmit the U2N reply/announcement (e.g., discovery message 520) or the U2N reply/announcement (e.g., discovery message 524) associated with an emergency service and having integrity protection based on a null integrity protection algorithm (e.g., be without integrity protection).

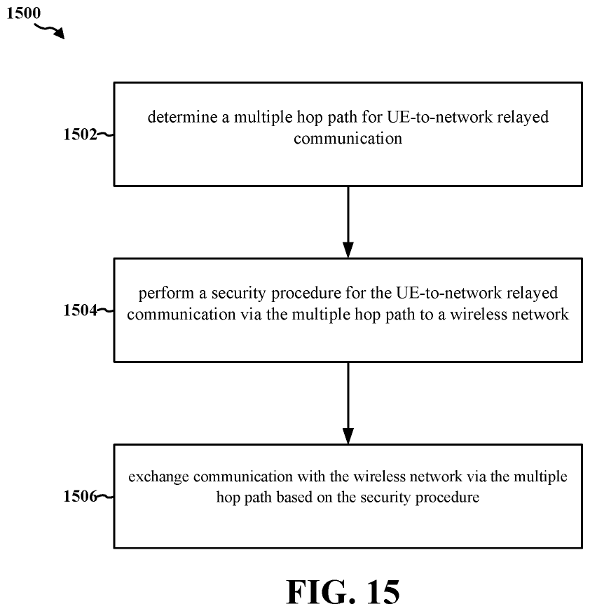

FIG. 15 is a flowchart 1500 of a method of wireless communication. The method may be performed by a UE (e.g., the UE 104, 350, 405, 406, 508, 608, 708, 808, 1008; the apparatus 1804). The method enables multi-hop security protection for secure multi-hop U2N discovery.

At step 1502, the UE determines a multiple hop path for UE-to-network relayed communication with a wireless network. The multiple hop path includes multiple relay UEs between the UE and the wireless network, e.g., a donor UE and one or more intermediate relay UEs. For example, 1502 may be performed by application processor(s) 1806, cellular baseband processor(s) 1824, and/or multi-hop component 198 of FIG. 18. FIGS. 8, 9 and 10 illustrate example aspects of a multi-hop path for U2N communication.

At step 1504, the UE performs a security procedure for the UE-to-network relayed communication via the multiple hop path to a wireless network. For example, 1504 may be performed by application processor(s) 1806, cellular baseband processor(s) 1824, transceiver(s) 1822, antenna(s) 1880, and/or multi-hop component 198 of FIG. 18. In some aspects, performing the security procedure for the multiple hop path includes: receiving a prose relay user key (PRUK) and PRUK ID from a network entity; providing a direct communication request to the wireless network via a donor relay UE and an intermediate relay UE in the multiple hop path between the UE and the wireless network; and establish a secure PC5 link with the intermediate relay UE based on a derived key associated with the PRUK (e.g., the PRUK associated with the PRUK ID). In some aspects, the derived key is a same derived key for the donor relay UE and the intermediate relay UE in the multiple hop path to the wireless network. For example, the key may correspond to K_{NRP} as described in connection with FIG. 8 or 9. In some aspects, the derived key is a second key that is derived from a first key associated with the donor relay UE. For example, the key may correspond to K_{NRP}′ or K_{NRP}″ as described in connection with FIG. 9 or 10. In some aspects, the security procedure is for a UP. FIGS. 7 and 10 illustrate example aspects of security procedures for the UP. In some aspects, the security procedure is for a CP. FIGS. 6, 8, and 9 illustrate example aspects of security procedures for the UP. FIGS. 8, 9, and 10 illustrate example aspects of security procedures for multi-hop U2N communication. FIGS. 6 and 7 illustrate examples aspects of security procedures for U2N communication.

At step 1506, the UE exchanges communication with the wireless network via the multiple hop path based on the security procedure. For example, 1506 may be performed by application processor(s) 1806, cellular baseband processor(s) 1824, transceiver(s) 1822, antenna(s) 1880, and/or multi-hop component 198 of FIG. 18. For example, the UE may transmit and/or receive wireless communication with the wireless network via the multiple hop path (e.g., U2N relayed communication) after the security procedure.

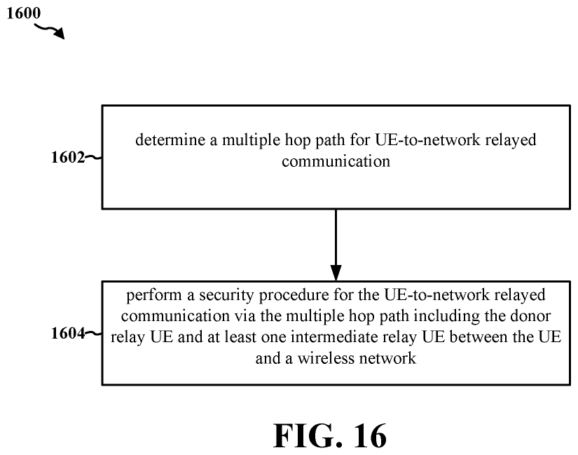

FIG. 16 is a flowchart 1600 of a method of wireless communication. The method may be performed by a UE such as a donor relay UE (e.g., the UE 104, 350, 405, 406, donor UE 504, 804, 1004; the apparatus 1904). The method enables multi-hop security protection for secure multi-hop U2N discovery.

At step 1602, the donor relay UE determines a multiple hop path for UE-to-network relayed communication. For example, 1602 may be performed by application processor(s) 1906, cellular baseband processor(s) 1924, and/or multi-hop component 199 of FIG. 19. FIGS. 8, 9, and 10 illustrate example aspects of a multi-hop path for U2N communication. FIG. 5A and FIG. 5B illustrate example aspects of a multi-hop U2N discovery procedure. FIGS. 6 and 7 illustrate examples aspects of security procedures for U2N communication.

At step 1604, the donor relay UE performs a security procedure for the UE-to-network relayed communication via the multiple hop path including the donor relay UE and at least one intermediate relay UE between the UE and a wireless network. For example, 1604 may be performed by application processor(s) 1906, cellular baseband processor(s) 1924, transceiver(s) 1922, antenna(s) 1980, and/or multi-hop component 199 of FIG. 19. FIGS. 8, 9 and 10 illustrate example aspects of a multi-hop path for U2N communication. In some aspects, performing the security procedure for the UE includes: receiving a direct communication request from the UE, wherein the communication request includes a PRUK ID for the UE; requesting a key to a network based on the PRUK ID; and obtaining a first key from the network. In some aspects, the donor relay UE may further provide a second key to at least one intermediate relay UE in the multiple hop path. In some aspects, the second key is a same key as the first key obtained by the donor relay UE. For example, the key may correspond to K_{NRP} as described in connection with FIG. 8 or 9. In some aspects, the donor relay UE may further derive the second key from the first key, wherein the second key is a different key than the first key. For example, the key may correspond to K_{NRP}′ or K_{NRP}″ as described in connection with FIG. 9 or 10. In some aspects, the security procedure is for a UP. FIGS. 6 and 10 illustrate example aspects of security procedures for the UP. In some aspects, the security procedure is for a CP. FIGS. 6, 8, and 9 illustrate example aspects of security procedures for the UP.

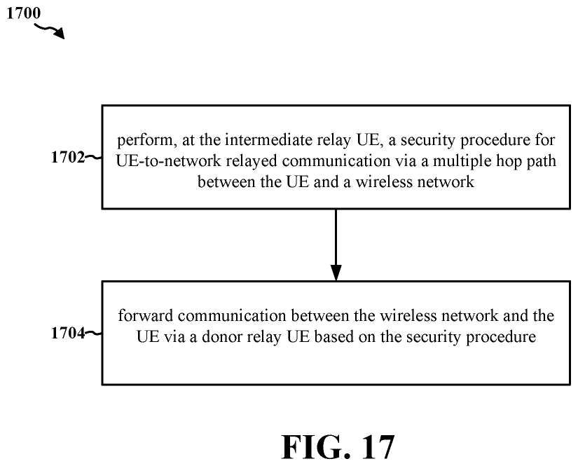

FIG. 17 is a flowchart 1700 of a method of wireless communication. The method may be performed by a UE such as a relay UE, which may be referred to as an intermediate relay UE, (e.g., the UE 104, 350, 405, 406, relay UE 505, 506, 604, 704, 805, 806, 1005, 1006; the apparatus 1904). The method enables multi-hop security protection for secure multi-hop U2N discovery.

At step 1702, the intermediate relay UE performs, at the intermediate relay UE, a security procedure for UE-to-network relayed communication via a multiple hop path between the UE and a wireless network. For example, 1604 may be performed by application processor(s) 1906, cellular baseband processor(s) 1924, transceiver(s) 1922, antenna(s) 1980, and/or multi-hop component 199 of FIG. 19. FIGS. 8, 9, and 19 illustrate example aspects of a multi-hop path for U2N communication. FIG. 5A and FIG. 5B illustrate example aspects of a multi-hop U2N discovery procedure. FIGS. 6 and 7 illustrate examples aspects of security procedures for U2N communication. In some aspects, the security procedure is for a UP. In some aspects, the security procedure is for a CP. FIGS. 7 and 10 illustrate example security procedures for a CP. FIG. FIGS. 6, 8, and 9 illustrate example aspects of security procedures for the UP.

In some aspects, performing the security procedure for the UE-to-network relayed communication via the multiple hop path includes: receiving a direct communication request from the UE, wherein the communication request includes a PRUK ID; requesting a key based on the PRUK ID; obtaining the key from the donor relay UE; and establishing secure communication with the UE based on the key. In some aspects, the key is a same key as for the donor relay UE. For example, the key may correspond to K_{NRP} as described in connection with FIG. 8 or 9. In some aspects, the key is a second key that is different than a first key for the donor relay UE, and wherein the second key is derived from the first key. For example, the second key may correspond to K_{NRP}′ as described in connection with FIG. 9 or 10. In some aspects, the intermediate relay UE may further provide a third key to an additional intermediate relay UE between the UE and the intermediate relay UE, wherein the third key is derived from the second key. For example, the third key may correspond to K_{NRP}′ or K_{NRP}″, as described in connection with FIG. 9 or 10.

At 1704, the intermediate relay UE forwards communication between the wireless network and the UE via a donor relay UE based on the security procedure. For example, 1604 may be performed by application processor(s) 1906, cellular baseband processor(s) 1924, transceiver(s) 1922, antenna(s) 1980, and/or multi-hop component 199 of FIG. 19. For example, the relay UE may forward wireless communication with the wireless network via the multiple hop path (e.g., U2N relayed communication) after the security procedure.

FIG. 18 is a diagram 1800 illustrating an example of a hardware implementation for an apparatus 1804. The apparatus 1804 may be a UE, a component of a UE, or may implement UE functionality. In some aspects, the apparatus may correspond to a remote UE, e.g., as described in connection with any of FIGS. 5A-10. In some aspects, the apparatus may operate as a donor UE or an intermediate relay UE, and may further include the multi-hop component 199 described in connection with FIG. 19. In some aspects, the apparatus 1804 may include at least one cellular baseband processor 1824 (also referred to as a modem) coupled to one or more transceivers 1822 (e.g., cellular RF transceiver). The cellular baseband processor(s) 1824 may include at least one on-chip memory 1824′. In some aspects, the apparatus 1804 may further include one or more subscriber identity modules (SIM) cards 1820 and at least one application processor 1806 coupled to a secure digital (SD) card 1808 and a screen 1810. The application processor(s) 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize one or more antennas 1880 for communication. The cellular baseband processor(s) 1824 communicates through the transceiver(s) 1822 via the one or more antennas 1880 with the UE 104 and/or with an RU associated with a network entity 1802. The cellular baseband processor(s) 1824 and the application processor(s) 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor(s) 1824 and the application processor(s) 1806 are each responsible for general processing, including the execution of software stored on the computer-readable medium/memory. The software, when executed by the cellular baseband processor(s) 1824/application processor(s) 1806, causes the cellular baseband processor(s) 1824/application processor(s) 1806 to perform the various functions described supra. The computer-readable medium/memory may also be used for storing data that is manipulated by the cellular baseband processor(s) 1824/application processor(s) 1806 when executing software. The cellular baseband processor(s) 1824/application processor(s) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) 1824 and/or the application processor(s) 1806, and in another configuration, the apparatus 1804 may be the entire UE (e.g., see UE 350 of FIG. 3) and include the additional modules of the apparatus 1804.

As discussed supra, the component 198 may be configured to receive a discovery message associated with UE-to-network relayed communication; determine a multiple hop discovery based at least on the discovery message; and verify the discovery message, wherein the discovery message is at least integrity protected. In some aspects, the component 198 may be configured to receive an additional discovery message associated with an emergency service without integrity protection, wherein the integrity protection for the discovery message uses a null integrity protection algorithm. In some aspects, the component 198 may be configured to determine a multiple hop path for UE-to-network relayed communication; perform a security procedure for the UE-to-network relayed communication via the multiple hop path to a wireless network; and exchange communication with the wireless network via the multiple hop path based on the security procedure. In some aspects, the component 198 may be configured to receive a PRUK and PRUK ID from a network entity; provide a direct communication request to the wireless network via a donor relay UE and an intermediate relay UE in the multiple hop path between the UE and the wireless network; and establish a secure PC5 link with the intermediate relay UE based on a derived key associated with the PRUK ID. The component 198 may be further configured to perform any of the aspects described in connection with the flowcharts in FIGS. 11, 12, and/or 15, and/or performed by the remote UE in the communication flows of any of FIGS. 5A-10. The component 198 may be within the cellular baseband processor(s) 1824, the application processor(s) 1806, or both the cellular baseband processor(s) 1824 and the application processor(s) 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor(s) 1824 and/or the application processor(s) 1806, may include means for receiving a discovery message associated with UE-to-network relayed communication; means for determining a multiple hop discovery based at least on the discovery message; and means for verifying the discovery message, wherein the discovery message is at least integrity protected. In some aspects, the apparatus 1804 may include means for receiving an additional discovery message associated with an emergency service without integrity protection, wherein the integrity protection for the discovery message uses a null integrity protection algorithm. In some aspects, the apparatus 1804 may include means for determining a multiple hop path for UE-to-network relayed communication; means for performing a security procedure for the UE-to-network relayed communication via the multiple hop path to a wireless network; and means for exchanging communication with the wireless network via the multiple hop path based on the security procedure. In some aspects, the apparatus 1804 may include means for receiving a PRUK and PRUK ID from a network entity; means for providing a direct communication request to the wireless network via a donor relay UE and an intermediate relay UE in the multiple hop path between the UE and the wireless network; and means for establishing a secure PC5 link with the intermediate relay UE based on a derived key associated with the PRUK ID. The apparatus 1804 may further include means for performing any of the aspects described in connection with the flowcharts in FIGS. 11, 12, and/or 15, and/or performed by the remote UE in the communication flows of any of FIGS. 5A-10. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 19 is a diagram 1900 illustrating an example of a hardware implementation for an apparatus 1904. The apparatus 1904 may be a UE, a component of a UE, or may implement UE functionality. In some aspects, the apparatus may correspond to a relay UE, e.g., a donor UE or an intermediate relay UE, e.g., as described in connection with any of FIGS. 5A-10. The apparatus may operate as a donor UE in some circumstances and may operate as an intermediate relay UE in other circumstances. In some aspects, the apparatus may operate as a remote UE, and may further include the multi-hop component 198 described in connection with FIG. 18. The apparatus 1904 may support relay UE operation, e.g., as described in connection with a donor UE or an intermediate relay UE. In some aspects, the apparatus 1804 may include at least one cellular baseband processor 1924 (also referred to as a modem) coupled to one or more transceivers 1922 (e.g., cellular RF transceiver). The cellular baseband processor(s) 1924 may include at least one on-chip memory 1924′. In some aspects, the apparatus 1904 may further include one or more subscriber identity modules (SIM) cards 1920 and at least one application processor 1906 coupled to a secure digital (SD) card 1908 and a screen 1910. The application processor(s) 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize one or more antennas 1980 for communication. The cellular baseband processor(s) 1924 communicates through the transceiver(s) 1922 via the one or more antennas 1980 with the UE 104 and/or with an RU associated with a network entity 1902. The cellular baseband processor(s) 1924 and the application processor(s) 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor(s) 1924 and the application processor(s) 1906 are each responsible for general processing, including the execution of software stored on the computer-readable medium/memory. The software, when executed by the cellular baseband processor(s) 1924/application processor(s) 1906, causes the cellular baseband processor(s) 1924/application processor(s) 1906 to perform the various functions described supra. The computer-readable medium/memory may also be used for storing data that is manipulated by the cellular baseband processor(s) 1924/application processor(s) 1906 when executing software. The cellular baseband processor(s) 1924/application processor(s) 1906 may be a component of the UE 350 and may include the at least one memory 360 and/or at least one of the TX processor 368, the RX processor 356, and the controller/processor 359. In one configuration, the apparatus 1904 may be at least one processor chip (modem and/or application) and include just the cellular baseband processor(s) 1924 and/or the application processor(s) 1906, and in another configuration, the apparatus 1904 may be the entire UE (e.g., see UE 350 of FIG. 3) and include the additional modules of the apparatus 1904.

As discussed supra, the component 199 may be configured to receive a discovery message associated with UE-to-network relayed communication; determine a multiple hop relaying of the discovery message; increment a hop count for the discovery message; protect integrity of the discovery message; and forward the discovery message having an incremented hop count. In some aspects, the multi-hop component 199 may be configured to providing an additional discovery message associated with an emergency service and having integrity protection based on a null integrity protection algorithm. In some aspects, the multi-hop component 199 may be configured to determine a multiple hop path for UE-to-network relayed communication; and perform a security procedure for the UE-to-network relayed communication via the multiple hop path including the donor relay UE and at least one intermediate relay UE between the UE and a wireless network. In some aspects, the multi-hop component 199 may be configured to receive a communication request from the UE, wherein the communication request includes a UE identifier (ID) for the UE; request a key to a network based on the UE ID; and obtain a first key from the network. In some aspects, the multi-hop component 199 may be configured to provide a second key to at least one intermediate relay UE in the multiple hop path. In some aspects, the multi-hop component 199 may be configured to derive the second key from the first key, wherein the second key is a different key than the first key. In some aspects, the multi-hop component 199 may be configured to perform, at the intermediate relay UE, a security procedure for UE-to-network relayed communication via a multiple hop path between the UE and a wireless network; and forward communication between the wireless network and the UE via a donor relay UE based on the security procedure. In some aspects, the multi-hop component 199 may be configured to receive a communication request from the UE, wherein the communication request includes a UE identifier (ID); request a key based on the UE ID; obtain the key from the donor relay UE; and establish secure communication with the UE based on the key. In some aspects, the multi-hop component 199 may be configured to provide a third key to an additional intermediate relay UE between the UE and the intermediate relay UE, wherein the third key is derived from the second key. The component 199 may be further configured to perform any of the aspects described in connection with the flowcharts in FIGS. 13, 14, 16, and/or 17, and/or performed by a relay UE in the communication flow of any of FIGS. 5A-10. The component 199 may be within the cellular baseband processor(s) 1924, the application processor(s) 1906, or both the cellular baseband processor(s) 1924 and the application processor(s) 1906. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1904 may include a variety of components configured for various functions. In one configuration, the apparatus 1904, and in particular the cellular baseband processor(s) 1924 and/or the application processor(s) 1906, may include means for receiving a discovery message associated with UE-to-network relayed communication; means for determining a multiple hop relaying of the discovery message; means for incrementing a hop count for the discovery message; means for protecting integrity of the discovery message; and means for forwarding the discovery message having an incremented hop count. In some aspects, the apparatus 1904 may include means for providing an additional discovery message associated with an emergency service and having integrity protection based on a null integrity protection algorithm. In some aspects, the apparatus 1904 may include means for determining a multiple hop path for UE-to-network relayed communication; and means for performing a security procedure for the UE-to-network relayed communication via the multiple hop path including the donor relay UE and at least one intermediate relay UE between the UE and a wireless network. In some aspects, the apparatus 1904 may include means for receiving a communication request from the UE, wherein the communication request includes a UE identifier (ID) for the UE; means for requesting a key to a network based on the UE ID; and means for obtaining a first key from the network. In some aspects, the apparatus 1904 may include means for providing a second key to at least one intermediate relay UE in the multiple hop path. In some aspects, the apparatus 1904 may include means for deriving the second key from the first key, wherein the second key is a different key than the first key. In some aspects, the apparatus 1904 may include means for performing, at the intermediate relay UE, a security procedure for UE-to-network relayed communication via a multiple hop path between the UE and a wireless network; and means for forwarding communication between the wireless network and the UE via a donor relay UE based on the security procedure. In some aspects, the apparatus 1904 may include means for receiving a communication request from the UE, wherein the communication request includes a UE identifier (ID); means for requesting a key based on the UE ID; means for obtaining the key from the donor relay UE; and means for establishing secure communication with the UE based on the key. In some aspects, the apparatus 1904 may include means for providing a third key to an additional intermediate relay UE between the UE and the intermediate relay UE, wherein the third key is derived from the second key. The apparatus 1904 may further include means for performing any of the aspects described in connection with the flowcharts in FIGS. 13, 14, 16, and/or 17, and/or performed by a relay UE in the communication flow of any of FIGS. 5A-10. The means may be the component 199 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: receiving a discovery message associated with UE-to-network relayed communication; determining a multiple hop discovery based at least on the discovery message; and verifying the discovery message, wherein the discovery message is at least integrity protected.

In aspect 2, the method of aspect 1, further including that the discovery message further includes hop count information for the multiple hop discovery, wherein verifying the discovery message is based at least in part on the hop count information.

In aspect 3, the method of aspect 1 or 2, further including that the discovery message comprises a discovery announcement message or a discovery request message.

In aspect 4, the method of any of aspects 1-3, further comprises: receiving an additional discovery message associated with an emergency service without integrity protection, wherein the integrity protection for the discovery message uses a null integrity protection algorithm.

Aspect 5 is a method of wireless communication at a relay UE, comprising: receiving a discovery message associated with UE-to-network relayed communication; determining a multiple hop relaying of the discovery message; incrementing a hop count for the discovery message; protecting integrity of the discovery message; and forwarding the discovery message having an incremented hop count.

In aspect 6, the method of aspect 5, further including that the discovery message comprises a discovery announcement message, a discovery solicitation message, or a discovery response message.

In aspect 7, the method of aspect 5 or 6, further comprises: providing an additional discovery message associated with an emergency service and having integrity protection based on a null integrity protection algorithm.

Aspect 8 is a method of wireless communication at a UE, comprising: determining a multiple hop path for UE-to-network relayed communication with a wireless network, the multiple hop path including multiple relay UEs between the UE and the wireless network; performing a security procedure for the UE-to-network relayed communication via the multiple hop path to the wireless network; and exchanging communication with the wireless network via the multiple hop path based on the security procedure.

In aspect 9, the method of aspect 8, further including that performing the security procedure for the multiple hop path includes: receiving a PRUK and PRUK ID from a network entity; providing a direct communication request to the wireless network via a donor relay UE and an intermediate relay UE in the multiple hop path between the UE and the wireless network; and establish a secure PC5 link with the intermediate relay UE based on a derived key associated with the PRUK.

In aspect 10, the method of aspect 9, further including that the derived key is a same derived key for the donor relay UE and the intermediate relay UE in the multiple hop path to the wireless network.

In aspect 11, the method of aspect 9, further including that the derived key is a second key that is derived from a first key associated with the donor relay UE.

In aspect 12, the method of any of aspects 8-11, further including that the security procedure is for a UP.

In aspect 13, the method of any of aspects 8-11, further including that the security procedure is for a CP.

Aspect 14 is a method of wireless communication at a donor relay UE, comprising: determining a multiple hop path for UE-to-network relayed communication; and performing a security procedure for the UE-to-network relayed communication via the multiple hop path including the donor relay UE and at least one intermediate relay UE between the UE and a wireless network.

In aspect 15, the method of aspect 14, further including that performing the security procedure for the UE includes: receiving a direct communication request from the UE, wherein the communication request includes a PRUK ID for the UE; requesting a key to a network based on the PRUK ID; and obtaining a first key from the network. In aspect 16, the method of aspect 15, further comprises: providing a second key to at least one intermediate relay UE in the multiple hop path.

In aspect 17, the method of aspect 16, further including that the second key is a same key as the first key obtained by the donor relay UE.

In aspect 18, the method of aspect 16, further comprises: deriving the second key from the first key, wherein the second key is a different key than the first key.

In aspect 19, the method of any of aspects 14-18, further including that the security procedure is for a UP.

In aspect 20, the method of any of aspects 14-18, further including that the security procedure is for a CP.

Aspect 21 is a method of wireless communication at an intermediate relay equipment (UE), comprising: performing, at the intermediate relay UE, a security procedure for UE-to-network relayed communication via a multiple hop path between the UE and a wireless network; and forwarding communication between the wireless network and the UE via a donor relay UE based on the security procedure.

In aspect 22, the method of aspect 21, further including that performing the security procedure for the UE-to-network relayed communication via the multiple hop path includes: receiving a direct communication request from the UE, wherein the communication request includes a PRUK ID; requesting a key based on the PRUK ID; obtaining the key from the donor relay UE; and establishing secure communication with the UE based on the key.

In aspect 23, the method of aspect 22, further including that the key is a same key as for the donor relay UE.

In aspect 24, the method of aspect 22, further including that the key is a second key that is different than a first key for the donor relay UE, and wherein the second key is derived from the first key.

In aspect 25, the method of aspect 24, further comprises: providing a third key to an additional intermediate relay UE between the UE and the intermediate relay UE, wherein the third key is derived from the second key.

In aspect 26, the method of any of aspects 21-25, further including that the security procedure is for a UP.

In aspect 27, the method of any of aspects 21-25, further including that the security procedure is for a CP.

Aspect 28 is an apparatus for wireless communication at a device including a memory and at least one processor coupled to the at least one memory and, based at least in part on stored information that is stored in the at least one memory, the at least one processor, individually or in any combination, is configured to implement any of aspects 1-4.

Aspect 29 is the apparatus of aspect 28, further including a transceiver or an antenna coupled to the at least one processor.

Aspect 30 is an apparatus for wireless communication at a device including means for implementing any of aspects 1-4.

Aspect 31 is a computer-readable medium (e.g., a non-transitory computer-readable medium) storing computer executable code, where the code when executed by one or more processors causes the one or more processors to implement any of aspects 1-4.

Aspect 32 is an apparatus for wireless communication at a device including a memory and at least one processor coupled to the at least one memory and, based at least in part on stored information that is stored in the at least one memory, the at least one processor, individually or in any combination, is configured to implement any of aspects 5-7.

Aspect 33 is the apparatus of aspect 32, further including a transceiver or an antenna coupled to the at least one processor.

Aspect 34 is an apparatus for wireless communication at a device including means for implementing any of aspects 5-7.

Aspect 35 is a computer-readable medium (e.g., a non-transitory computer-readable medium) storing computer executable code, where the code when executed by one or more processors causes the one or more processors to implement any of aspects 5-7.

Aspect 36 is an apparatus for wireless communication at a device including a memory and at least one processor coupled to the at least one memory and, based at least in part on stored information that is stored in the at least one memory, the at least one processor, individually or in any combination, is configured to implement any of aspects 8-13.

Aspect 37 is the apparatus of aspect 36, further including a transceiver or an antenna coupled to the at least one processor.

Aspect 38 is an apparatus for wireless communication at a device including means for implementing any of aspects 8-13.

Aspect 39 is a computer-readable medium (e.g., a non-transitory computer-readable medium) storing computer executable code, where the code when executed by one or more processors causes the one or more processors to implement any of aspects 8-13.

Aspect 40 is an apparatus for wireless communication at a device including a memory and at least one processor coupled to the at least one memory and, based at least in part on stored information that is stored in the at least one memory, the at least one processor, individually or in any combination, is configured to implement any of aspects 14-20.

Aspect 41 is the apparatus of aspect 40, further including a transceiver or an antenna coupled to the at least one processor.

Aspect 42 is an apparatus for wireless communication at a device including means for implementing any of aspects 14-20.

Aspect 43 is a computer-readable medium (e.g., a non-transitory computer-readable medium) storing computer executable code, where the code when executed by one or more processors causes the one or more processors to implement any of aspects 14-20.

Aspect 44 is an apparatus for wireless communication at a device including a memory and at least one processor coupled to the at least one memory and, based at least in part on stored information that is stored in the at least one memory, the at least one processor, individually or in any combination, is configured to implement any of aspects 21-27.

Aspect 45 is the apparatus of aspect 44, further including a transceiver or an antenna coupled to the at least one processor.

Aspect 46 is an apparatus for wireless communication at a device including means for implementing any of aspects 21-27.

Aspect 47 is a computer-readable medium (e.g., a non-transitory computer-readable medium) storing computer executable code, where the code when executed by one or more processors causes the one or more processors to implement any of aspects 21-27.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to cause the UE to:
receive a discovery message associated with UE-to-network relayed communication;
determine a multiple hop discovery based at least on the discovery message; and
verify the discovery message, wherein the discovery message is at least integrity protected.

2. The apparatus of claim 1, wherein the discovery message further includes hop count information for the multiple hop discovery, wherein a verification of the discovery message is based at least in part on the hop count information.

3. The apparatus of claim 1, wherein the discovery message comprises a discovery announcement message or a discovery request message.

4. The apparatus of claim 1, wherein the at least one processor, individually or in any combination, is further configured to cause the UE to:
receive an additional discovery message associated with an emergency service without integrity protection, wherein the integrity protection for the discovery message uses a null integrity protection algorithm.

5. The apparatus of claim 1, further comprising a transceiver coupled to the at least one processor, the transceiver being configured to receive the discovery message.

6. An apparatus for wireless communication at a relay user equipment (UE), comprising:
at least one memory; and
at least one processor coupled to the at least one memory and, based at least in part on stored information that is stored in the at least one memory, the at least one processor, individually or in any combination, is configured to cause the relay UE to:
receive a discovery message associated with UE-to-network relayed communication;
determine a multiple hop relaying of the discovery message;
increment a hop count for the discovery message;
protect integrity of the discovery message; and
forward the discovery message having an incremented hop count.

7. The apparatus of claim 6, wherein the discovery message comprises a discovery announcement message, a discovery solicitation message, or a discovery response message.

8. The apparatus of claim 6, wherein the at least one processor, individually or in any combination, is further configured to cause the relay UE to:
provide an additional discovery message associated with an emergency service and having integrity protection based on a null integrity protection algorithm.

9. The apparatus of claim 6, further comprising a transceiver coupled to the at least one processor, the transceiver being configured to receive the discovery message.

10. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to cause the UE to:
determine a multiple hop path for UE-to-network relayed communication with a wireless network, the multiple hop path including multiple relay UEs between the UE and the wireless network;
perform a security procedure for the UE-to-network relayed communication via the multiple hop path to the wireless network; and
exchange communication with the wireless network via the multiple hop path based on the security procedure.

11. The apparatus of claim 10, wherein to perform the security procedure for the multiple hop path, the at least one processor, individually or in any combination, is further configured to cause the UE to:
receive a prose relay user key (PRUK) and PRUK identifier (ID) from a network entity;
provide a direct communication request to the wireless network via a donor relay UE and an intermediate relay UE in the multiple hop path between the UE and the wireless network; and
establish a secure PC5 link with the intermediate relay UE based on a derived key associated with the PRUK.

12. The apparatus of claim 11, wherein the derived key is a same derived key for the donor relay UE and the intermediate relay UE in the multiple hop path to the wireless network.

13. The apparatus of claim 11, wherein the derived key is a second key that is derived from a first key associated with the donor relay UE.

14. The apparatus of claim 10, wherein the security procedure is for a user plane (UP).

15. The apparatus of claim 10, wherein the security procedure is for a control plane (CP).

16. The apparatus of claim 10, further comprising a transceiver coupled to the at least one processor, the transceiver being configured to exchange the communication with the wireless network.

17. An apparatus for wireless communication at a donor relay user equipment (UE), comprising:
at least one memory; and
at least one processor coupled to the at least one memory and, based at least in part on stored information that is stored in the at least one memory, the at least one processor, individually or in any combination, is configured to cause the donor relay UE to:
determine a multiple hop path for UE-to-network relayed communication; and
perform a security procedure for the UE-to-network relayed communication via the multiple hop path including the donor relay UE and at least one intermediate relay UE between the UE and a wireless network.

18. The apparatus of claim 17, wherein to perform the security procedure for the multiple hop path, the at least one processor, individually or in any combination, is configured to cause the donor relay UE to:
receive a direct communication request from the UE, wherein the direct communication request includes a prose relay user key (PRUK) (ID) for the UE;
request a key to a network based on the PRUK ID; and
obtain a first key from the network.

19. The apparatus of claim 18, wherein the at least one processor, individually or in any combination, is further configured to cause the donor relay UE to:
provide a second key to an intermediate relay UE in the multiple hop path.

20. The apparatus of claim 19, wherein the second key is a same key as the first key obtained by the donor relay UE.

21. The apparatus of claim 19, wherein the at least one processor, individually or in any combination, is further configured to cause the donor relay UE to:
derive the second key from the first key, wherein the second key is a different key than the first key.

22. The apparatus of claim 17, wherein the security procedure is for a user plane (UP).

23. The apparatus of claim 17, wherein the security procedure is for a control plane (CP).

24. An apparatus for wireless communication at an intermediate relay equipment (UE), comprising:
at least one memory; and
at least one processor coupled to the at least one memory and, based at least in part on stored information that is stored in the at least one memory, the at least one processor, individually or in any combination, is configured to cause the intermediate relay UE to:
perform, at the intermediate relay UE, a security procedure for UE-to-network relayed communication via a multiple hop path between the UE and a wireless network; and
forward communication between the wireless network and the UE via a donor relay UE based on the security procedure.

25. The apparatus of claim 24, wherein, to perform the security procedure for the UE-to-network relayed communication via the multiple hop path, the at least one processor, individually or in any combination, is further configured to cause the intermediate relay UE to:
receive a direct communication request from the UE, wherein the direct communication request includes a prose relay user key (PRUK) identifier (ID);
request a key based on the PRUK ID;
obtain the key from the donor relay UE; and
establish secure communication with the UE based on the key.

26. The apparatus of claim 25, wherein the key is a same key as for the donor relay UE.

27. The apparatus of claim 25, wherein the key is a second key that is different than a first key for the donor relay UE, and wherein the second key is derived from the first key.

28. The apparatus of claim 27, further comprising a transceiver coupled to the at least one processor, wherein the at least one processor, individually or in any combination, is further configured to cause the intermediate relay UE to:
provide a third key to an additional intermediate relay UE between the UE and the intermediate relay UE, wherein the third key is derived from the second key.

29. The apparatus of claim 24, wherein the security procedure is for a user plane (UP).

30. The apparatus of claim 24, wherein the security procedure is for a control plane (CP).
